(19) United States
(12) Patent Application Publication
(10) Pub. No.: US 2015/0023342 A1
(43) Pub. Date: Jan. 22, 2015

(54) METHOD FOR OPERATING OF PEER AWARE COMMUNICATION NETWORK

(71) Applicant: Electronics and Telecommunications Research Institute, Daejeon (KR)

(72) Inventor: Seong-Soo Joo, Daejeon (KR)

(21) Appl. No.: 14/334,341

(22) Filed: Jul. 17, 2014

(30) Foreign Application Priority Data
Jul. 17, 2013 (KR) 10-2013-0083896
Jul. 17, 2014 (KR) 10-2014-0090580

(51) Int. Cl. H04W 56/00; H04W 74/04; H04W 74/08; H04L 29/08

(52) U.S. Cl. CPC H04W 56/001; H04L 67/1087; H04W 74/04; H04W 74/08
USPC 370/350

(57) ABSTRACT

In a peer aware communication network, a method in which a peer device accesses a link includes: determining a phase based on service which is provided to another peer device; and accessing a link which is included in a superframe that a predetermined length according to the phase, a method of reserving resources and a method of avoiding interference are provided.

### CROSS-REFERENCE TO RELATED APPLICATION

This application claims priority to and the benefit of Korean Patent Application Nos. 10-2013-0083896 and 10-2014-0090580 filed in the Korean Intellectual Property Office on Jul. 17, 2013 and Jul. 17, 2014, respectively, the entire contents of which are incorporated herein by reference.

### BACKGROUND OF THE INVENTION

(a) Field of the Invention

The present invention relates to a method of operating a peer aware communication (PAC) network including a method of accessing a link of a peer device included in the PAC network, a method of reserving a resource, and a method of avoiding interference.

(b) Description of the Related Art

In the Internet of things (IoT) technology, in order for things that are located at the same space to recognize a situation change of space and to adaptively react to an event, grouping between things and cooperation between grouped things is requested.

A plurality of things that are located at the same space may belong to at least one group, operate as a client or a server of a peer to peer (P2P) service and transmit/receive control information, sensing information, location information, advertisements, or multimedia contents.

For this purpose, in order to access various resources, the plurality of things should form a P2P network.

In the conventional art on a network configuration based on a low power wireless link, there is an IEEE 802.15.4-based standard.

Conventionally, wireless personal area network (WPAN) technology controls a network and a master coordinator for a network configuration to form a P2P link between full function devices.

However, it is difficult for a device to simultaneously participate in a plurality of networks, so it provides a plurality of P2P links without overall control in the plurality of networks.

Further, when a device simultaneously participates in a plurality of networks, a link resource of all peer service groups that are included in a space should be used optimally for peer communication. Therefore, an access control method that may avoid collision between messages and an autonomous link resource allocation method are requested.

Further, A protocol between devices that are included in a peer service group based on a low-energy wireless link is required for operating each peer service group that are included in a space.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of accessing a link resource, a method of reserving resource, and a method of avoiding interference, for operating at least one peer service group.

### BRIEF DESCRIPTION OF THE DRAWINGS

FIG. 1 is a diagram illustrating a plurality of peer service groups that are included in a space, and a plurality of things on which a wireless device is equipped that are included in the plurality of peer service groups.

FIG. 2 is a diagram illustrating a peer service group using low-energy wireless links according to an exemplary embodiment of the present invention.

FIG. 3 is a diagram illustrating an address frame that includes an address of a peer service group according to an exemplary embodiment of the present invention.

FIG. 4 is a diagram illustrating an address frame that includes an address of a device according to an exemplary embodiment of the present invention.

FIG. 5 is a diagram illustrating a device profile of a peer service group according to an exemplary embodiment of the present invention.

FIG. 6 is a diagram illustrating a device advertisement frame which a peer transmits according to an exemplary embodiment of the present invention.

FIG. 7 is a diagram illustrating an MPDU frame according to an exemplary embodiment of the present invention.

FIG. 8 is a diagram illustrating a MAC frame according to another exemplary embodiment of the present invention.

FIG. 9 is a diagram illustrating a network topology of a peer service group according to an exemplary embodiment of the present invention.

FIG. 10 is a diagram illustrating a resource allocation scheme according to an exemplary embodiment of the present invention.

FIG. 11 is a diagram illustrating a phase configuration method of a peer service according to an exemplary embodiment of the present invention.

FIG. 12 is a diagram illustrating a superframe of each phase according to an exemplary embodiment of the present invention.

FIG. 13 is a diagram illustrating a link resource access method according to an exemplary embodiment of the present invention.

FIG. 14 is a diagram illustrating a superframe structure according to another exemplary embodiment of the present invention.

FIG. 15 is a diagram illustrating a superframe structure and cyclic superframe structure according to an exemplary embodiment of the present invention.

FIG. 16 is a diagram illustrating a cyclic superframe according to another exemplary embodiment of the present invention.

FIG. 17 is a diagram illustrating interference avoidance between heterogeneous superframes according to an exemplary embodiment of the present invention

FIG. 18 is a flowchart illustrating an initialization method according to an exemplary embodiment of the present invention.

FIG. 19 is a flowchart illustrating a method of generating a peer service group according to an exemplary embodiment of the present invention.

FIG. 20 is a diagram illustrating a peer discovery request frame according to an exemplary embodiment of the present invention.

FIG. 21 is a diagram illustrating a timeslot of a PAC device that synchronizes with a master clock of a peer service group according to an exemplary embodiment of the present invention.

FIG. 22 is a diagram illustrating a synchronization frame according to an exemplary embodiment of the present invention.

FIG. 23 is a diagram illustrating a resource allocation scheduling method of a peer service group according to an exemplary embodiment of the present invention.

FIG. 24 is a diagram illustrating timeslots allocated to a peer discovery phase and a P2P phase according to an exemplary embodiment of the present invention.

FIG. 25 is a diagram illustrating timeslots allocated to a peer discovery phase and a P2P phase according to another exemplary embodiment of the present invention.

FIG. 26 is a flowchart illustrating an interference mitigation method according to an exemplary embodiment of the present invention.

FIG. 27 is a diagram illustrating a peer group generated between peer service groups according to an exemplary embodiment of the present invention.

FIG. 28 is a diagram illustrating broadcasting of a PAC device group according to an exemplary embodiment of the present invention.

FIG. 29 is a diagram illustrating a multi-hop relaying method according to an exemplary embodiment of the present invention.

FIG. 30 is a diagram illustrating multi-hop relaying method according to another exemplary embodiment of the present invention.

FIG. 31 is a diagram illustrating relative positioning according to an exemplary embodiment of the present invention.

FIG. 32 is a diagram illustrating interaction of a peer service group with an upper layer according to an exemplary embodiment of the present invention.

FIG. 33 is a diagram illustrating a network service method and a link resource allocation method according to an exemplary embodiment of the present invention.

FIG. 34 is a flowchart illustrating a PDME-START procedure according to an exemplary embodiment of the present invention.

FIG. 35 is a flowchart illustrating a PDME-DISCOVER procedure according to an exemplary embodiment of the present invention.

FIG. 36 is a flowchart illustrating a PDME-ADVERTISE procedure according to an exemplary embodiment of the present invention.

FIG. 37 is a flowchart illustrating a PDME-PEER procedure according to an exemplary embodiment of the present invention.

FIG. 38 is a flowchart illustrating a PD-DATA procedure according to an exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive.

Like reference numerals designate like elements throughout the specification.

In an entire specification, a peer device may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

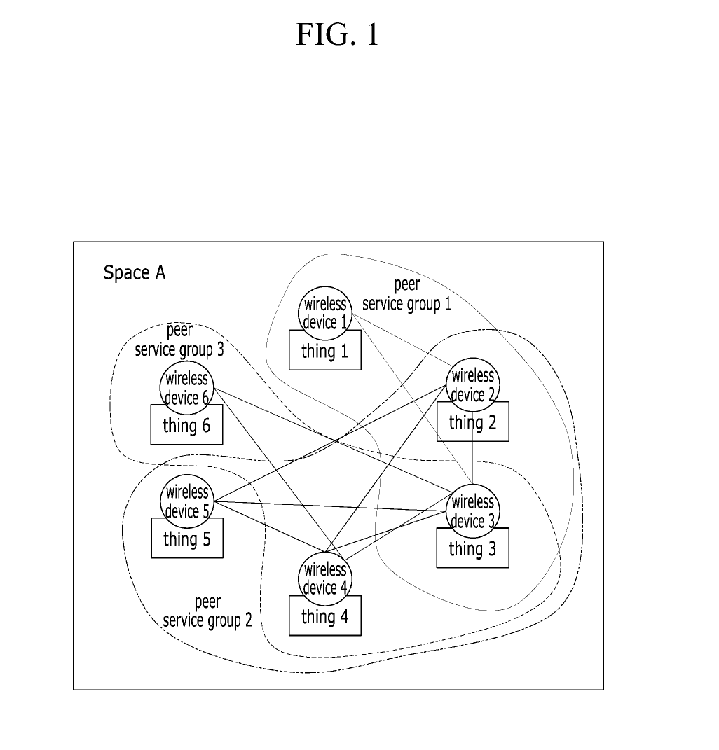

FIG. 1 is a diagram illustrating a plurality of peer service groups that are included in a space, and a plurality of things on which a wireless device is equipped that are included in the plurality of peer service groups.

Referring to FIG. 1, a plurality of peer service groups exists at a random space A. A plurality of things are included in each peer service group and are equipped with wireless devices. The plurality of things may communicate with other things by the wireless devices, may be provided services from the peer service groups, and may perform services.

For example, referring to FIG. 1, a thing 1, a thing 2, and a thing 3 may form a group 1 and perform a service 1. The thing 2, the thing 3, a thing 4, and a thing 5 may form a group 2 and perform a service 2. The thing 3, the thing 4, and a thing 6 may form a group 3 and perform a service 3. Each peer service group may share the things. Referring to FIG. 1, the thing 2 and the thing 4 simultaneously participate in the peer service group 1 and the peer service group 2. The thing 3 simultaneously participates in the peer service group 1, the peer service group 2, and the peer service group 3.

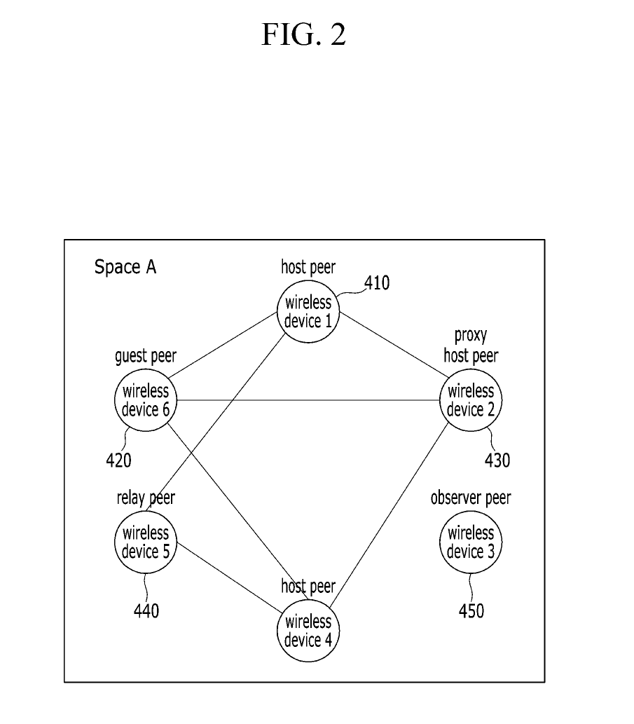

FIG. 2 is a diagram illustrating a peer service group using low-energy wireless links according to an exemplary embodiment of the present invention.

In an exemplary embodiment of the present invention, the peer service group may include a peer aware communication (PAC) network, and each peer may discover other peers, generate a peer service group with the discovered peers, or participate in another peer service group.

A peer service group according to the exemplary embodiment of the present invention may include a host peer 410 and a guest peer 420 as a primary element, it may include a proxy host peer 430 and a relay peer 440 as an auxiliary element, and it may include an observer peer 450.

The host peer 410 is a peer that can generate a peer service group and provide a P2P service through the peer service group. In this case, the host peer 410 may be an initiator of the peer service group as an element that can initiate a peer service. Further, the host peer 410 may define a mission and a peer group of the peer service group and authenticate another peer that requests a subscription.

The guest peer 420 is a peer that participates in a peer service group, provides a service to a peer that is included in the peer service group, and receives a service from another peer. In this case, the guest peer 420 may be a participant that participates in the peer service group.

The proxy host peer 430 is a peer that performs as a host of a peer service group as a substitute for the host peer 410. For example, the proxy host peer 430 may perform as a host as a substitute for the host peer 410 when the host peer 410 leaves the peer service group or the host peer 410 requests the proxy host peer 430 to perform the host function.

The relay peer 440 is a peer that may relay a message in a peer service group. That is, the relay peer 440 may relay a message between peers when a wireless link is not connected between the host peer 410 and the guest peer 420 or between guest peers.

The observer peer 450 may not participate in a configuration of the peer service group, but may observe a message that is transmitted and received between the host peer 410 and the guest peer 420.

A link of the peer service group includes a host-guest link, a host-proxy host link, a proxy host-guest link, a host-relay link, and a guest-relay link, and in each link, a radio channel resource and a time resource are distributed as communication resources.

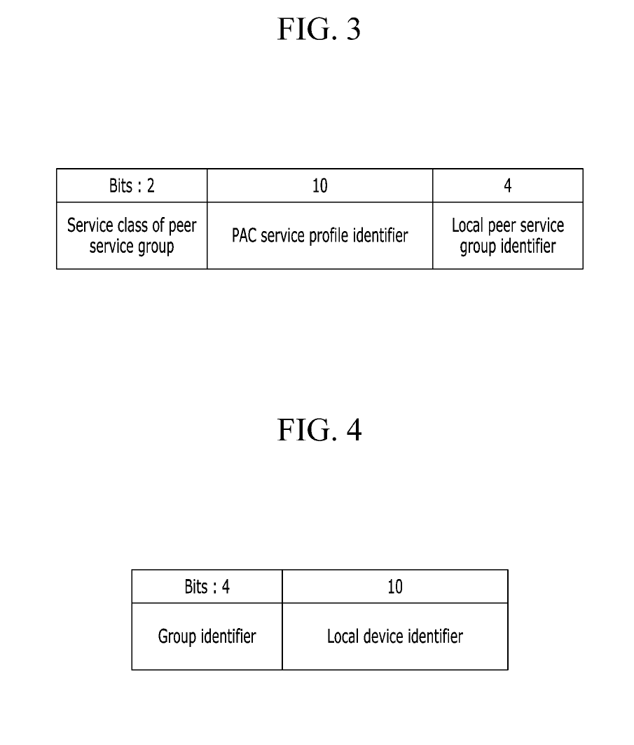

FIG. 3 is a diagram illustrating an address frame that includes an address of a peer service group according to an exemplary embodiment of the present invention.

Referring to FIG. 3, peer service group ID may include a service class of a peer service group, a service profile identifier, and a local peer service group identifier. In this case, the service class is about a service priority of the peer service group. The service profile identifier may be used for identifying a service that is provided by the peer service group and needs to get a registry. The local peer network identifier may be used for identifying a neighbor peer service group that provides the same service.

FIG. 4 is a diagram illustrating an address frame that includes an address of a device according to an exemplary embodiment of the present invention.

Referring to FIG. 4, a device ID includes a global device identifier and a local device identifier. The global device identifier may be 64 bits in length and the local device identifier may be 16 bits in length.

The local device identifier may include a group identifier, a local PAC device identifier and a reserved local PAC device identifier for a special purpose. The group identifier ‘0x0’ is a local device identifier that is included in a peer service group, and the group identifier ‘0xf’ represents a broadcast to the peer service group.

The local PAC device identifier may be an exclusive identifier of the peer service group and may be generated by hashing based on the global device identifier, capability of a device, and the service profile identifier of the peer service group.

The examples of reserved local PAC device identifier for special purpose are listed as follows.
0x000: initiator of a peer service group
0x001: proxy initiator of a peer service group
0xfff: broadcast (with ID indicator 0xf) or groupcast (with ID indicator 0x0)

A PAC device in proximity in an exemplary embodiment of the present invention may be identified through the combination of a network ID, a group ID, and a local device ID. A PAC device may have a plurality of peer IDs.

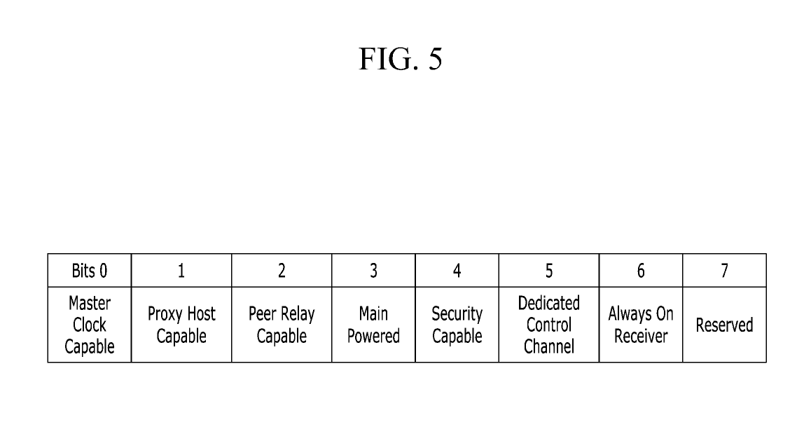

FIG. 5 is a diagram illustrating a device profile of a peer service group according to an exemplary embodiment of the present invention.

In the exemplary embodiment of the present invention, the device profile of a peer service group is required by each PAC device that has a plurality of device addresses of a peer service group.

A device capability of the device profile may represent master clock capable, host capable, proxy host capable and relay capable. Further, the device capability of the device profile may represent a dedicated control channel PHY and an always on receiver PHY. Further, the device capability of the device profile may represent main powered and security capability.

A service capability of the device profile may represent a list of capable peer network service profiles.

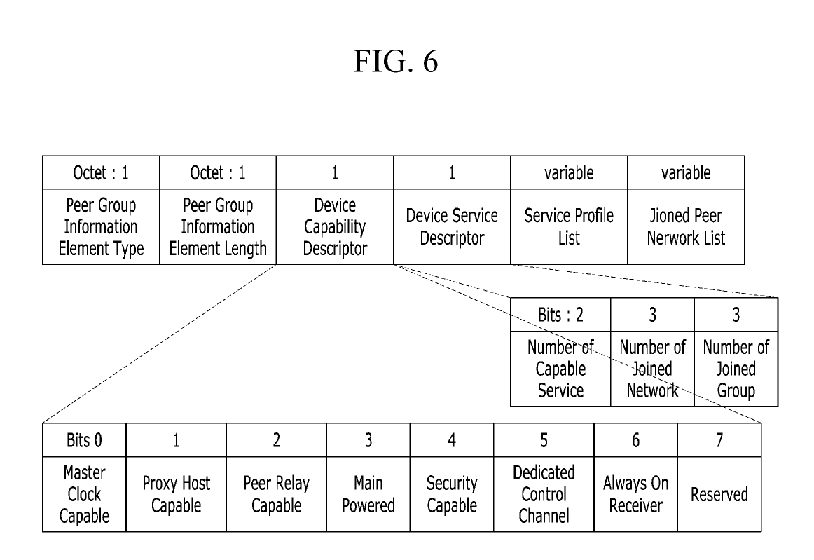

FIG. 6 is a diagram illustrating a device advertisement frame which a peer transmits according to an exemplary embodiment of the present invention.

In the exemplary embodiment of the present invention, the device advertisement frame may be used for a PAC device (i.e., a peer device) that performs a successful initialization to periodically report the device's status.

The device advertisement frame according to the exemplary embodiment of the present invention may include a device capability, a device service capability, a service profile list, and a joined peer network list.

In this case, a device that does not participate in a peer service group may be omitted from the list field of the subscribed peer service group. In addition, a transmission cycle of a device advertisement frame transmitted by a PAC device that does not participate in a peer service group may be shorter than another transmission cycle of a device advertisement frame transmitted by another PAC devices included in the peer service group.

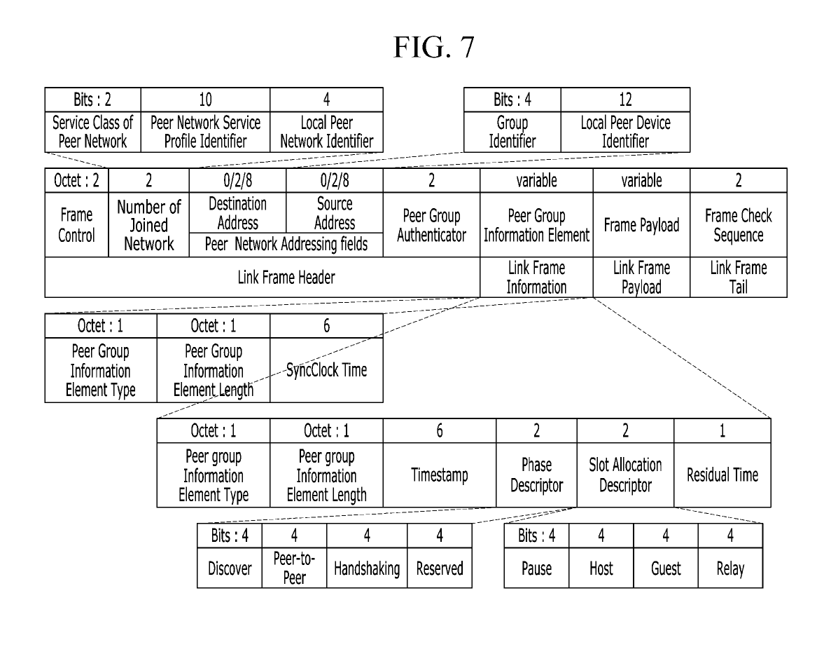

FIG. 7 is a diagram illustrating an MPDU frame according to an exemplary embodiment of the present invention.

Referring to FIG. 7, the MPDU frame in an exemplary embodiment of the present invention may include a link frame header, a link frame information, a link frame payload and a link frame tail.

The link frame header may include a frame control field, a peer service group identifier (or peer network identifier), a peer service group address (or peer network address) and a peer service group authenticator (or peer network authenticator).

In this case, the frame control field may include a version of the frame (3 bits), a type of the frame (3 bits) and a length of the frame (10 bits).

The type of the frame includes a broadcast, a peer discover, a peer service group management and a peer service group data. Further, the type of the frame may include a pre-network formation and an after-network formation. In addition, the type of the frame may include information of a control frame, data a frame, and a broadcast frame in proximity.

Further, the link frame header may include a peer service group ID that includes information about the service type and the network profile, a PAC device address, and a peer network authenticator.

The peer service group identifier may include a service class of a peer service group (2 bits), a service profile ID of a peer service group (10 bits), a number of a peer service group, or a local peer service group ID (or local peer network ID). The number of a peer service group may be an exclusive number in the peer service group that uses the same service profile.

Further, in the link frame header, an address of the PAC device means a destination address and a departure address, and may include two types of addresses (64-bit address and 8-bit address allocated each peer service group).

The peer service group authenticator may include a pre-defined key and a 64-bit address of the peer device.

The link frame information may include a type, a length, and a value of the link frame. Further, the link frame information may include a peer service group information element (peer network information element). The peer service group information element may include information of a type, a length, and a value. Further, the peer service group information element may include pre-network management information and after-network management information.

The pre-network management information may include clock synchronization information of a peer service group, PAC device advertisement information, peer discovery information and peer link connection information.

The peer discovery information may include a phase descriptor, a slot allocation descriptor, a remaining time to phase expiration, or a start time of next phase.

The network management information may include information about a peer beacon, a peer grouping, a peer groupcast, peer relaying, and a peer link release.

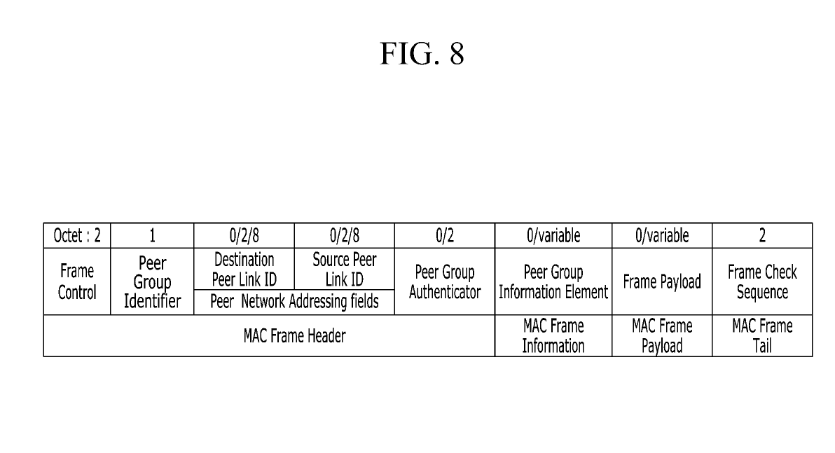

FIG. 8 is a diagram illustrating a MAC frame according to another exemplary embodiment of the present invention.

Referring to FIG. 8, the MAC frame according to another exemplary embodiment of the present invention may include a MAC frame header, MAC frame information elements, a MAC frame payload and a MAC frame tail.

A frame control field of the MAC frame header may include a version, a frame type, a destination link ID indicator, a source link ID indicator, and an information element indicator (IE indicator).

In this case, an advertise request (Advertise Req.), discovery request/response (Discover Req./Resp.), a peer request/response (Peer Req./Resp.), a de-peer request/response (DePeer Req./Resp.), a re-peer request (RePeer Req.), and a data frame may be determined by the frame type.

A peer group ID field of the MAC frame header may include a peer group service type (3 bits) and a local group ID (5 bits). A peer link ID field of the MAC frame header may include a PAC device ID (12 bits) and a peer link ID (4 bits). The MAC frame header may include a peer group authenticator field. The MAC frame information elements may include information for a type, a length, and a value of the frame, and peer group information elements related to a management command. The MAC frame tail may include a frame check sequence.

The frame that is used for advertise request or a discover request may include ‘header (3 bytes)+payload (variable)+tail (2 bytes)’. The frame that is used for peer request/response may include ‘header (5 bytes)+information element (4 bytes)+tail (2 bytes)’. The frame that is used for data transmission may include ‘header (5 bytes)+information element (3 bytes)+payload (variable)+tail (2 bytes)’.

In an exemplary embodiment of the present invention, a frame filtering scheme to a MAC layer is described as follows.

Frame Filtering

The first frame filtering that is applied to all frames is for checking the type of peer group service. All received frames are filtered and a frame that is wrong (not matched) type may be discarded.

Second Frame Filtering

The second frame filtering that is applied to all frames except the discovery request/response frame is for checking the local group ID. A frame transmitted from same peer service group may be discarded.

Third Frame Filtering

The third frame filtering is for checking the PAC device ID and link ID and a frame that has matched ID may be forwarded to an higher layer. In the third frame filtering, the relaying capability of the frame may be checked even though a frame that has a wrong PAC device ID or link ID may be discarded.

Fourth Frame Filtering

The fourth frame filtering is for checking a relaying information element. If a frame arrives on a correct link, the frame may be relayed to an outward device by transmitting the frame to the outward link.

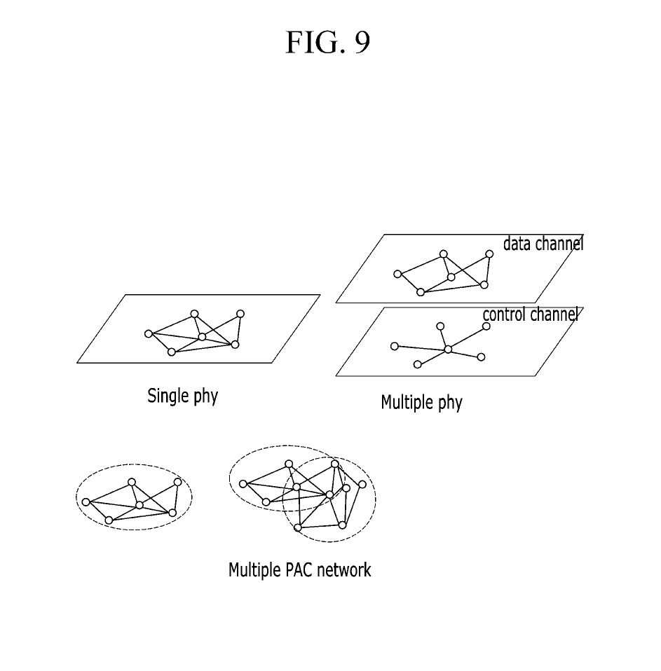

FIG. 9 is a diagram illustrating a network topology of a peer service group according to an exemplary embodiment of the present invention.

In an exemplary embodiment of the present invention, a link resource may be determined by the PHY. That is, the number of physically separated links that work concurrently may determine the link resource. In this case, a dedicated PHY link for the control channel may be generated and the link resource should be adjusted in accordance with the radio channel and spatial channel. The link resource may be allocated in the time domain.

In an exemplary embodiment of the present invention, the manner of contention may solve the scheme for access to the link resource. For example, the contention between PAC devices that are included in a single peer service group may be solved through scheduling, and the contention between PAC devices that are included in multiple peer service groups may be solved through interference avoidance.

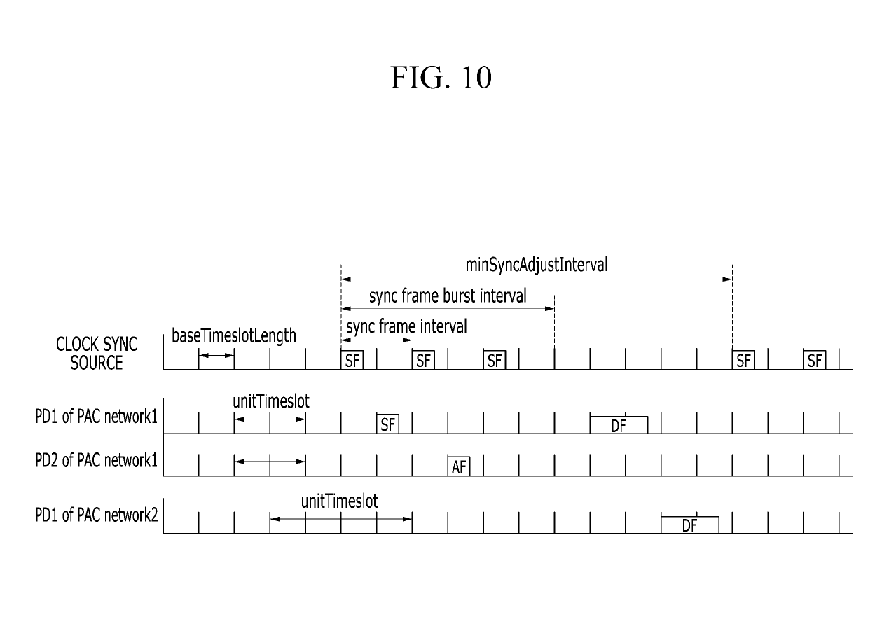

FIG. 10 is a diagram illustrating a resource allocation scheme according to an exemplary embodiment of the present invention.

In FIG. 10, a link resource is allocated in the time domain. The link resource allocation in the time domain, a time scale for all constituent elements that are included in a peer service group, and a clock synchronization source for the peer service group are required. Referring to FIG. 10, synchronized scheduling is possible and each PAC device may avoid interferences that can occur between a plurality of peer service groups by advertising the schedule of resource allocation to neighbor peer service groups. A unit resource that is represented with a time length may be used for transmitting a clock synchronization frame (link frame of 16 bytes). The length of a unit timeslot may be an integer multiple of a base timeslot.

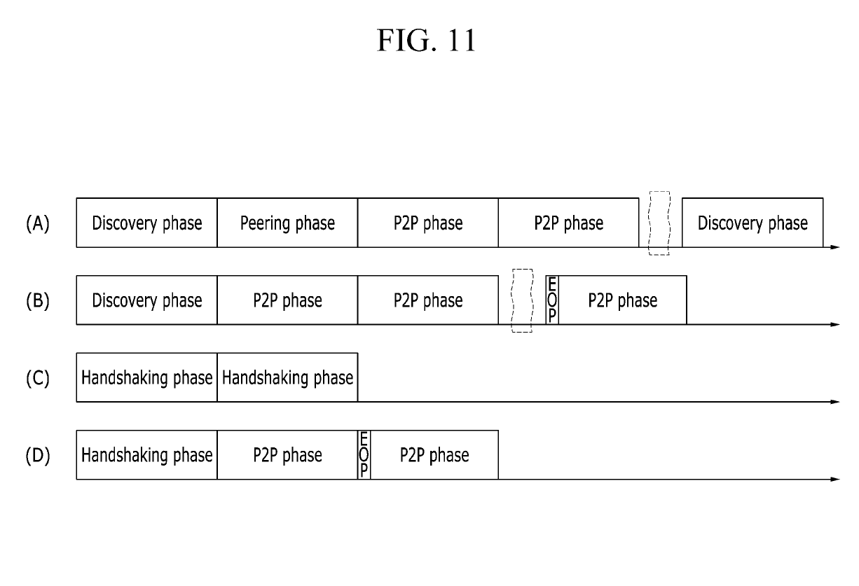

FIG. 11 is a diagram illustrating a phase configuration method of a peer service according to an exemplary embodiment of the present invention.

A peer service group according to an exemplary embodiment of the present invention may apply a different link resource allocation method to each service level, and the link resource allocation method may be represented by an order of the phase that includes the superframe. The phase of a peer service group may include a discovery phase, a peering phase, a P2P phase, and a handshaking phase. The discovery phase is a discovery step in which an advertisement of a host peer is transmitted to form a steady peer service group, and a device of the peer service group is discovered to associate when the peer service group is continually operated and maintained. The peering phase is a step in which a link resource is allocated to a target peer of a subscriber after the discovery phase. The handshaking phase is a step that allocates a link resource for discovering a peer and exchanging data without peering. A configuration of the superframe that is included in each service phase may be configured in accordance with a service profile.

FIG. 11 (A) represents a service of a peer service group when the peer service group is continually operated and maintained for a long time. In this case, a discovery phase, a peering phase, and a P2P phase are deployed by turns. A release of peer service group may be determined by a peer service group release command of the host peer 410.

FIG. 11 (B) represents a service of a peer service group when the peer service group is operated and maintained for a short time. In this case, an extended P2P phase is deployed after a discovery phase. A release of peer service group may be determined when the host peer 410 notifies that a certain P2P phase is the last phase (end of P2P, EOP).

FIG. 11 (C) represents a service of a peer service group when a mobile communication device forms a peer service group in an instant and data transmission is allowed in a short time. In this case, only the handshaking phase may be deployed.

FIG. 11 (D) represents a service of a peer service group when a mobile communication device forms a peer service group in an instant and data transmission is allowed in a relatively long time. In this case, a P2P phase is deployed after a handshaking phase. A release of a peer service group may be determined when the host peer 410 notifies of the EOP or no P2P data is transmitted during a predetermined time period.

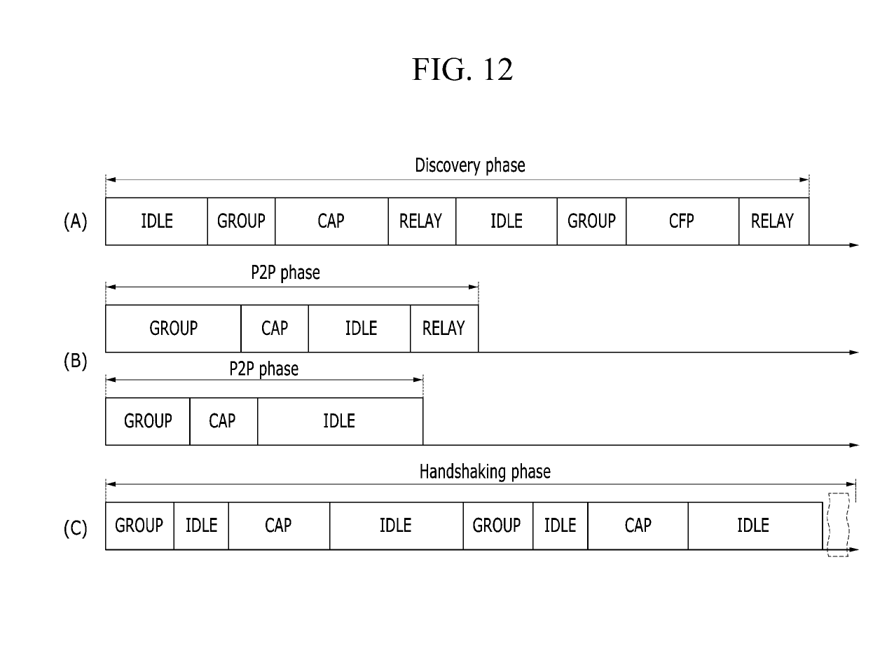

FIG. 12 is a diagram illustrating a superframe of each phase according to an exemplary embodiment of the present invention.

Referring to FIG. 12 (A), an idle link period, a group link period, a contention link period, and a relay link period are deployed in order in the superframe of the discovery phase. A length of a timeslot is determined on each link period basis.

In this case, the deployment pattern of the link resources and the length of the timeslot may be changed in accordance with the target time that is needed for generating a peer service group, a scale of peer members of the peer service group (for example, the number of the peers included in multiple peer service groups), and a transmission range of the peer service group.

In the discovery phase, the host peer 410 may determine the idle link period, and may determine the superframe start time by discovering at least one neighbor peer service group. Thereafter, the host peer 410 may transmit a discovery message, which includes a peer service group descriptor, a discovery phase descriptor, and a peer phase descriptor, in the group link period. The relay peer 440 that receives the discovery message may retransmit the discovery message in the relay link period.

In the discovery phase, the guest peer 420 may maintain a listen mode by a predetermined timeslot according to a wake-up cycle by a quorum operation of the peer service group. In this case, the guest peer 420 is the observer peer 450 and may collect information by discovering an adjacent peer service group. When the guest peer 420 finds a hosting message, the guest peer 420 may transmit a hosting response together with information of the adjacent peer service group in a near guest link period.

Referring to FIG. 12 (B), in the P2P phase, a group link period, a contention link period, a non-contention link period, an idle link period, and a relay link period are sequentially deployed, and a length of a timeslot is determined on each link period basis.

In this case, a pattern in which a link resource is deployed and the length of the timeslot may be changed according to a mission of the peer service group, a scale of a message that is generated between peers, the number of peer service groups, and a transmission range of the peer service group.

A link access may follow an existing link access method according to a link device.

Referring to FIG. 12 (C), at the handshaking phase, a group link period, an idle link period, a contention link period and an idle link period are sequentially deployed, and a length of a timeslot is determined on each link period basis. In this case, a pattern in which a link resource is deployed and the length of the timeslot may be changed according to a target time that is needed for collecting information of the peer service group, a scale of a peer member of the peer service group, a mission of the peer service group, and a magnitude of a message that is generated between peers. A link access may follow an existing link access method according to a link device. A combination of link resource allocation may be repeated to form a handshaking phase.

In the handshaking phase, the host peer 410 transfers a hosting message including a peer service group descriptor, handshaking phase descriptor, and a P2P phase descriptor (may not be included according to a case) in a host link period. When a link resource allocation method is formed with only a handshaking phase, the guest peer 420 may transmit a data message. In the handshaking phase, a relay does not operate.

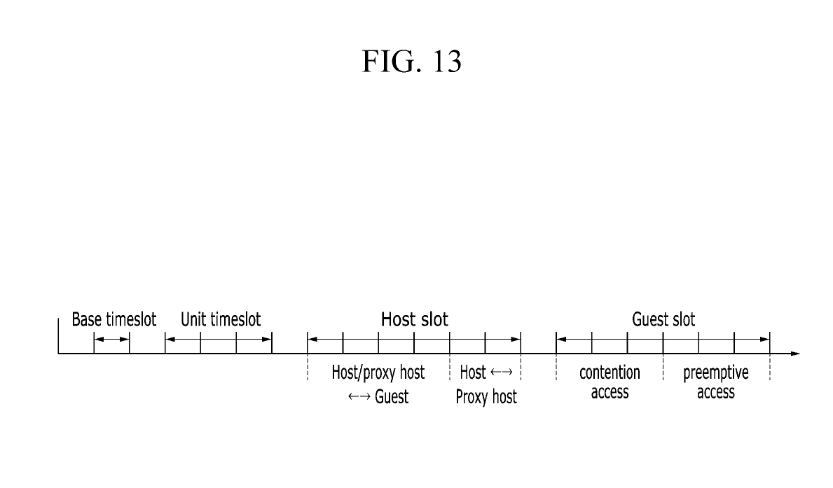

FIG. 13 is a diagram illustrating a link resource access method according to an exemplary embodiment of the present invention.

The method of link resource access to a host slot and a guest slot may be selected from among tx without clear channel assessment (CCA), tx with equal CCA, tx with prioritized CCA, and preemptive slot assignment.

A host slot may include a host portion in which the host peer or proxy host peer can possess a priority and a proxy host connection portion for connecting between the host and the proxy host. The host peer of the proxy host peer may transmit a frame without CCA at the start point of the host slot. A guest peer may transmit a frame to the host peer at the host portion after performing the CCA. In this case, the backoff of the CCA may be determined by using a local device identifier to which the access priority is applied, and the probability of contention access varies between guest peers. A higher channel secured priority is provided to the host peer rather than the proxy host peer in the proxy host connection portion, and the host peer may access link resources after performing CCA.

The guest slot may include a contention access portion and a preemptive access portion. In the contention access slot, a delay time until trying CCA on the start point of the guest slot basis and a backoff time until re-trying CCA as channel congestion may be determined through the local device identifier to which the access priority of each device is applied. Also in the contention access slot, the probability of contention access varies between guest peers. In the preemptive access slot, a slot number to be allocated to each peer device may be determined by hashing the number of the preemptive access slot and the local device identifier in consideration of the priority.

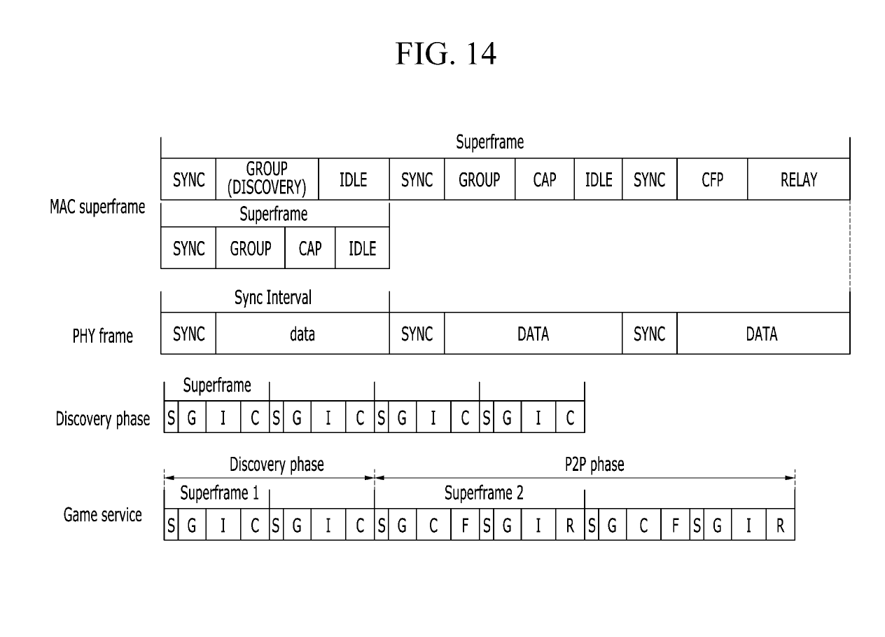

FIG. 14 is a diagram illustrating a superframe structure according to another exemplary embodiment of the present invention.

In accordance with another exemplary embodiment of the present invention, a PAC device included in a peer service group may competitively access a link resource according to a link period that is designated in the superframe. In this case, the length of the superframe may be an integer multiple of a sync interval. The sync interval is an interval between sync slots of a connected PHY frame. A link resource allocation time and link resource access scheme designated in the superframe may be differently designated according to each service phase or the type of the service. The superframe may be periodically repeated.

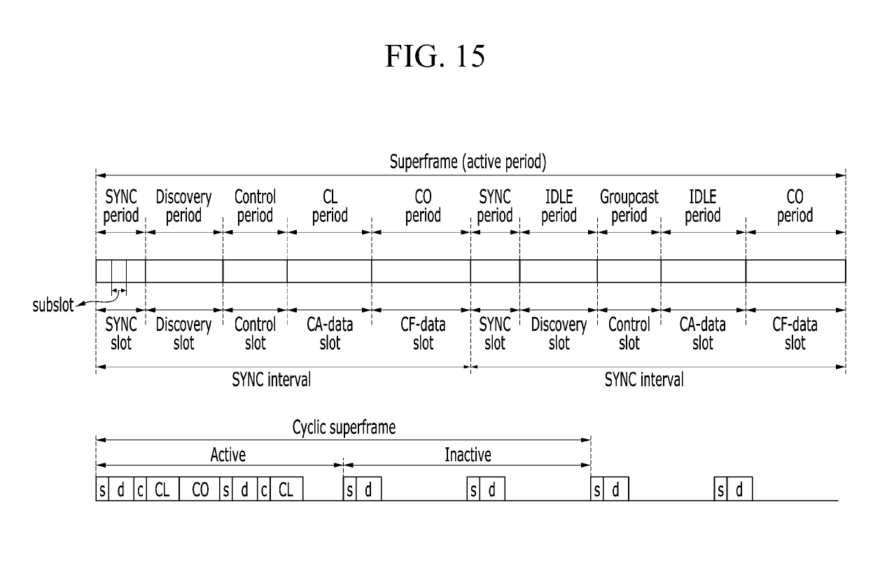

FIG. 15 is a diagram illustrating a superframe structure and a cyclic superframe structure according to an exemplary embodiment of the present invention.

Referring to FIG. 15, the superframe according to an exemplary embodiment of the present invention may use a synchronization interval (SI) that includes at least one of a synchronization slot (SYNC slot), a discovery slot, a control slot, a contention access (CA) data slot, a contention free (CF) data slot, or an idle slot. The SI may include sub-slots of a fixed number. For example, one sub-slot may have a 12 μs length, and one SI may include 8334 sub-slots (SI=100.008 ms).

In an exemplary embodiment of the present invention, a MAC layer superframe may include two SIs, and a sync period, a discovery period, a control period, a connectionless (CL) link period, a connection-oriented (CO) link period, a sync period, a discovery period, an idle period, an idle period, and a CO link period may be allocated in order in the superframe as a link resource.

In an exemplary embodiment of the present invention, a cyclic superframe may include a plurality of SIs. The cyclic superframe may include an active period that includes n superframes and an inactive period that includes m superframes. In this case, the m superframes included in the inactive period may consist of at least one idle period. For example, the superframe illustrated in FIG. 14 is a superframe that is included in the active period.

The use of a slot included in a superframe may be determined in accordance with the service type. For example, an idle slot may be inserted between a plurality of slots (a sync slot, a discovery slot, a control slot, a CA data slot, or a CF data slot), or the length of an idle slot may be adjusted according to the service type.

A superframe according to an application service may follow at least one of 7 types of superframes as follows.

Type 1: Unidirectional Connectionless Message Transmission Service

A PAC device may transmit an advertisement frame or a discovery frame along with data. The superframe used in the type 1 service may include a SI that includes sync-discovery-idle-CL-idle periods.

Type 2: Bidirectional Connectionless Message Transmission Service

A PAC device may transmit a request frame or a response frame along with data. The superframe used in the type 2 service may include an SI that includes sync-discovery-control-CL-idle periods and another SI that includes sync-discovery-idle-CL-idle periods.

Type 3: Delay Tolerant Message Transmission Service

A PAC device may generate a CA link after discovering. The superframe used in the type 3 service may include an SI that includes sync-discovery-control-CL-idle periods.

Type 4: Mixed Type of Traffic Service

A superframe supports a mixed type traffic service. The superframe used in the type 4 service may include an SI that includes sync-discovery-control-CL-CO-idle periods and another SI that includes sync-discovery-idle-CL-idle periods.

Type 5: Reliable Message Transmission Service

A PAC device may generate a CA link after discovering. The superframe used in the type 5 service may include an SI that includes sync-discovery-control-idle-CO periods.

Type 6: Open Configurable Superframe Service

A PAC device may select slot use of sequential slots included in the SI and the length of the superframe. The superframe of the type 6 service may be advertised by a superframe structure information element.

When a plurality of peer service groups of which the service types are different each other simultaneously transmit a frame, the transmission priority at the same slot may be “type 6>type 5>type 4> . . . >type 1” in accordance with the service type.

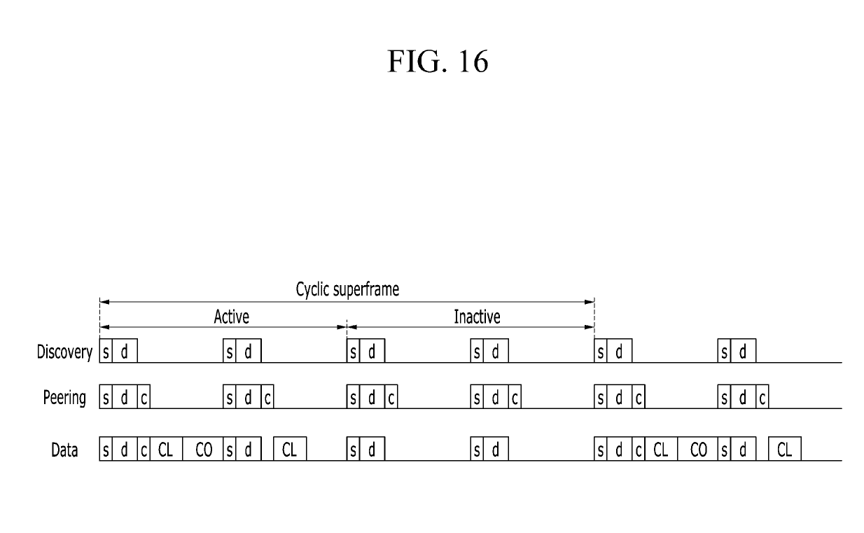

FIG. 16 is a diagram illustrating a cyclic superframe according to another exemplary embodiment of the present invention.

In accordance with another exemplary embodiment of the present invention, a MAC cyclic superframe may be provided through MAC layer primitives by un upper layer. In this case, the higher layer may determine a service type, and the number of active superframes, and inactive superframes.

Referring to FIG. 16, the active superframe may include an SI that includes sync-discovery-control-CL-idle periods and another SI that includes sync-idle-control-CL-idle periods. In this case, some period of the inactive superframe may be used as follows.

In the discovery phase, the discovery slot may be included in the inactive superframe.

In the peering phase, the control slot may be included in the inactive superframe.

In the P2P phase, the inactive superframe may include only an idle period and no sync period.

For example, a type 4 cyclic superframe may include one active superframe and one inactive superframe.

In this case, the active superframe may include an SI that includes sync-discovery-control-CL-CO periods and another SI that includes sync-discovery-idle-CL-idle periods.

An address of link resource may indicate two PAC devices that are located at opposite sides according to a peer link ID. The peer link ID may include a peer device ID (12 bits) and a peer link ID (4 bits). The link period included in the cyclic superframe may be identified through the order of the superframe included in the cyclic superframe, the order of the period and the number of the slot included in the period. A contention access period (CAP) may include a superframe sequential ID and a CL period sequential ID, and a contention free period (CFP) may include a superframe sequential ID, a CO period sequential ID and a slot ID.

In another exemplary embodiment of the present invention, a distributed resource reservation scheme may be used.

In a peering process, the distributed resource reservation scheme may be applied as follows.

In the type 3 service and the type 4 service, a CL period may be allocated in the cyclic superframe as the peering request.

In the type 3 service, the type 5 service, and the type 6 service, a source PAC device of a unidirectional link may scan control slots of an adjacent peer before reserving a CFP slot. The source PAC device may select a superframe, a CO period, and at least one slot in the basis of a hashing value of peer link ID. Thereafter, the source PAC device requests a reservation of at least one slot by transmitting a peering request to another PAC device.

A destination PAC device of the uni-directional link may receive the peering request in the resource allocated for the link. The destination PAC device checks an available slot by scanning the control slot of an adjacent PAC device. Thereafter, the destination PAC device may transmit ACK or adjusted slot allocation to the source PAC device through the link.

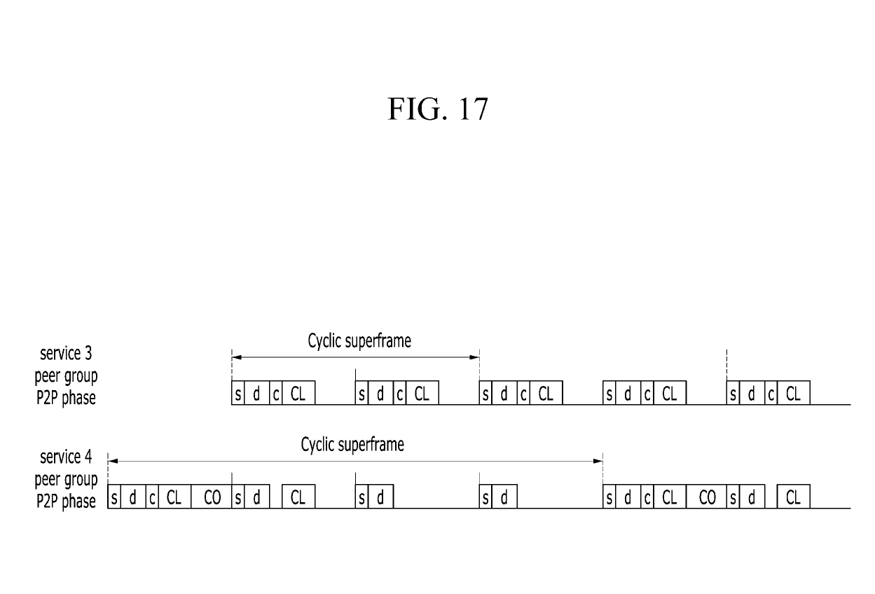

FIG. 17 is a diagram illustrating interference avoidance between heterogeneous superframes according to an exemplary embodiment of the present invention

Referring to FIG. 17, an access control method for a participant that participates in a multiple peer service group and an access control method for the initiator may be applied to interference avoidance between the multiple peer service groups.

When the participant performs the access control to the multiple peer service groups, the participant may follow a priority of a service type between the peer service groups.

When the initiator performs the access control, the initiator may select the start time of a cyclic superframe and follow a priority of a service type between the peer service groups. Thereafter, the initiator may perform opportunistic transmission on the basis of designed statistical access.

For example, the interference avoidance method is described when the peer service group of a type 3 service that includes two active superframes without inactive superframes and the peer service group of a type 4 service that includes one active superframe and one inactive superframe co-exist. When the peer service group of a type 3 service and the peer service group of a type 4 service co-exist, each peer service group is in the P2P phase. In this case, when the CL periods interfere with each other, the peer service group of type 4 service may apply a shorter backoff and the interference can be avoided.

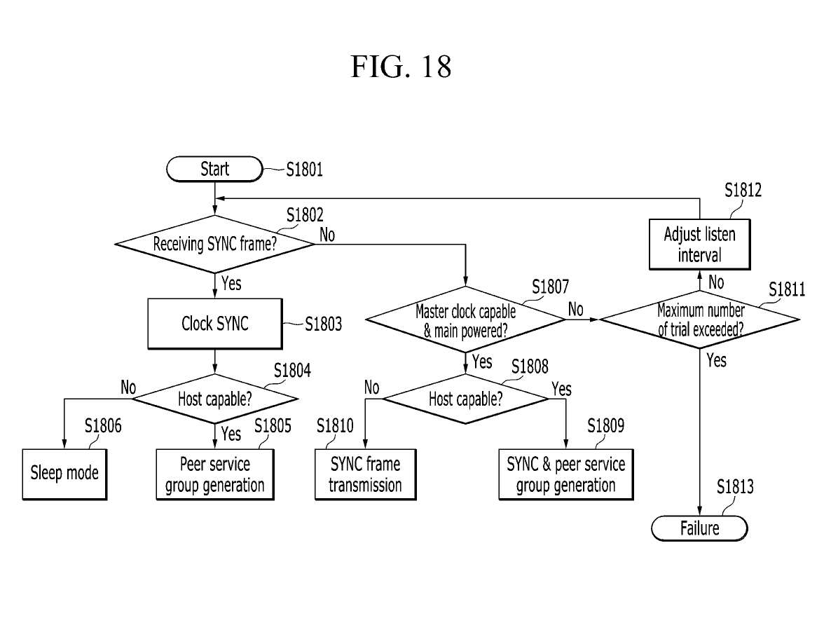

FIG. 18 is a flowchart illustrating an initialization method according to an exemplary embodiment of the present invention.

A peer of a peer service group according to an exemplary embodiment of the present invention may have device capability information and network service capability information as initial information. The role of the peer may be determined in accordance with the initial information (device capability information and network service capability information) stored in the peer (S1801).

The device capability information may include information about master clock capable, proxy host capable, peer relay capable, main powered, security capable, dedicated control channel, and always on receiver.

The network service capability information is information about capability of the network for supporting an application service of a wireless peer service group, and may include information about host capable, real-time capable, reliable connection capable, group connection capable, and burst traffic capable.

Referring to FIG. 18, first of all, the powered peer receives a frame of an adjacent network (S1802). Thereafter, the peer receives a network clock synchronization frame, and the peer synchronizes its own clock according to the synchronization frame (S1803).

If the network service capability information is ‘host capable’, the peer starts to generate a peer service group (S1805). If the network service capability information is not ‘host capable’, the peer sets a wake-up time and converts a mode thereof to a sleep mode (S1806).

However the peer receives a frame except the network clock synchronization frame (that is, the peer does not receive the network clock synchronization frame), and checks the device capability information (S1807).

If the device capability information is ‘master clock capable’ and ‘main powered’, the peer checks the network service capability information (S1808). If the network service capability information is ‘host capable’, the peer performs synchronization, searches an adjacent peer, and starts to generate a peer service group (S1809). If the network service capability information is not ‘host capable’, the peer may periodically transmit a synchronization frame as a network clock master (S1810).

If the device capability information does not include ‘master clock capable’ and ‘main powered’, the peer adjusts the sync listen interval and re-performs the synchronization (S1811, S1812).

In this case, if clock synchronization has not succeeded within the number of synchronization attempts, i.e., if the number of predetermined synchronization attempts is exceeded, the peer does not perform synchronization (S1813).

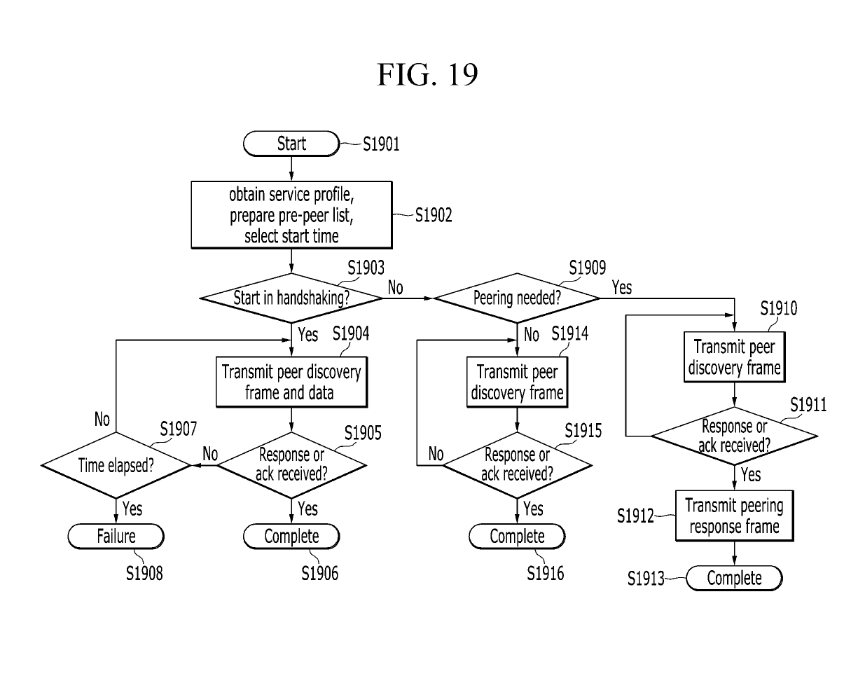

FIG. 19 is a flowchart illustrating a method of generating a peer service group according to an exemplary embodiment of the present invention.

The host peer analyzes a service profile of the peer service group and determines information about a network service procedure, a kind of constituting devices of the network, the minimum request number of the constituting devices, and scheduling information that allocates a link resource on a network phase basis (S1901). Thereafter, the host peer determines a pre-peer list and the start time of the peer service group from the clock synchronization procedure or the device advertisement frame of the adjacent frame (S1902).

In this case, the generation of the peer service group may differ in accordance with the order of the network phase.

If the service of the peer service group starts from the handshaking phase (S1903), the host peer simultaneously transmits data frame along with the peer discovery frame (S1904).

If a peer discovery response or peer data ACK is received within a predetermined time (S1905), the host peer completes generation of the peer service group (S1906).

If the peer discovery response or the peer data ACK is not received within the predetermined time, the host peer retransmits the discovery frame and data frame.

Thereafter, if the peer discovery response or the peer data ACK is not received within the predetermined time, the host peer determines this to be a failure of generation of the peer service group (S1908).

If the service of the peer service group does not start from the handshaking phase, i.e., the service starts from the peer discovery phase, the host peer determines whether the peering is requested or not (S1909).

If the peering is unnecessary, the host peer transmits a peer discovery request (S1914) and awaits a response for a predetermined time (S1915).

If the response is not received within the predetermined time, the host peer retransmits the peer discovery frame.

If the response is not received within the predetermined time despite retransmission, the host peer determines this to be a failure of generation of the peer service group.

However, if the response is received within the predetermined time, the host peer starts the peer communication phase (S1916).

If the peering is necessary at step 1909, the host peer transmits a peer discovery frame (S1910) and awaits a response for a predetermined time (S1911).

If the response is not received within the predetermined time, the host peer retransmits the peer discovery frame.

If the response is not received within the predetermined time despite retransmission of the host peer, the host peer determines this to be a failure of generation of the peer service group.

If the response is received within the predetermined time, the host peer completes the peering by transmitting a peering response frame to the peer which transmits the response (S1912, S1913).

Thereafter, the host peer starts the peer communication phase.

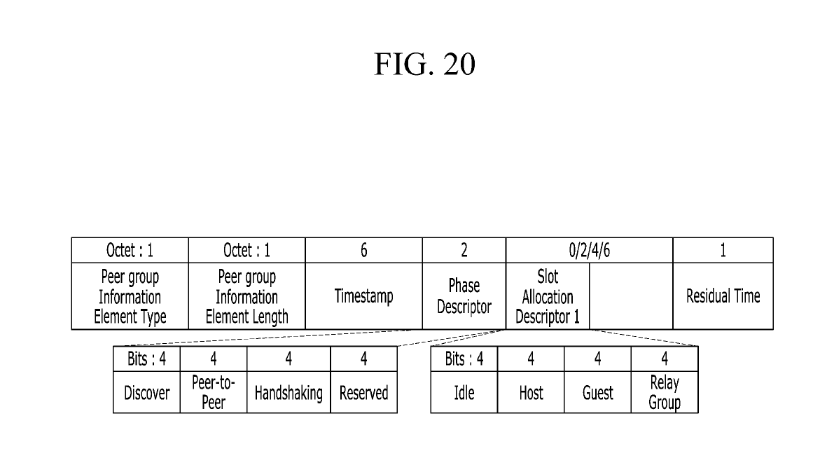

FIG. 20 is a diagram illustrating a peer discovery request frame according to an exemplary embodiment of the present invention.

A peer discovery may be begun from when receiving an advertisement frame of another PAC device or transmitting a peer discovery request frame. In this case, the peer discovery request frame may include a service profile of a peer service group and peer service group formation information. The service profile of the peer service group may be a peer service group identifier, and may provide a category of the service that is provided by the peer service group. The peer service group formation information may be a phase descriptor and a slot allocation descriptor.

A discovering interval may be a synchronization interval of the peer service group and wake-up interval of a PAC device.

The host peer broadcasts the peer discovery frame each Td. Thereafter, a PAC device that can provide the peer service transmits a response for the peer discovery frame, and synchronizes with the host peer. At this time, the address and the capability of the PAC device that is capable of the peer service may be transmitted to the host peer along with the response. Thereafter, the host peer notifies a network starting time to each PAC device.

The peer discovery frame may provide a phase duration time. Also the peer discovery frame may provide a slot allocation schedule of each phase.

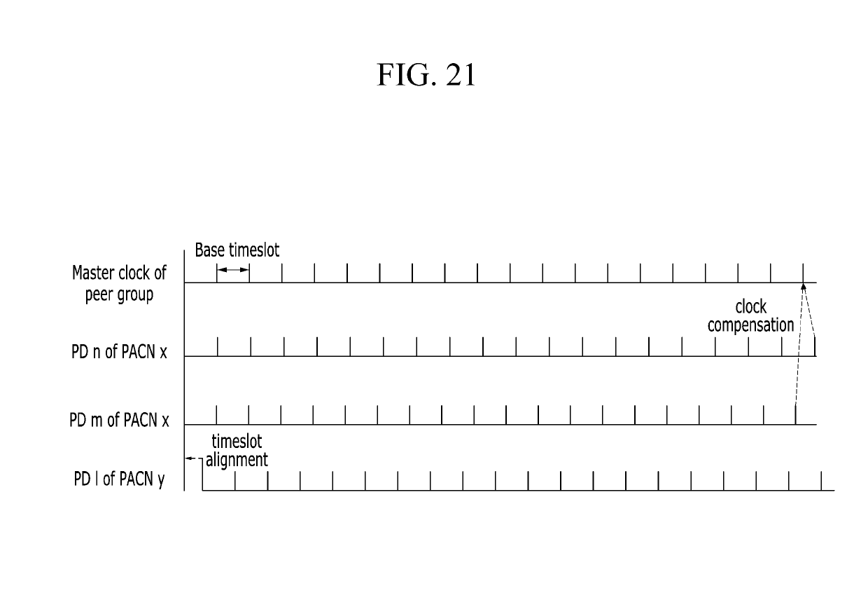

FIG. 21 is a diagram illustrating a timeslot of a PAC device that synchronizes with a master clock of a peer service group according to an exemplary embodiment of the present invention.

In an exemplary embodiment of the present invention, the PAC device included in each peer service group may synchronize its own clock with a master clock of a peer service group.

Referring to FIG. 21, the PAC device ‘a’ and the PAC device ‘b’ of the peer service group ‘x’ should synchronize the length of a base timeslot with the master clock's timeslot. In this case, each PAC device may synchronize the clock by compensating an oscillator drift (clock compensation).

The PAC device ‘c’ of the peer service group ‘y’ should align the start point of a base timeslot (timeslot alignment).

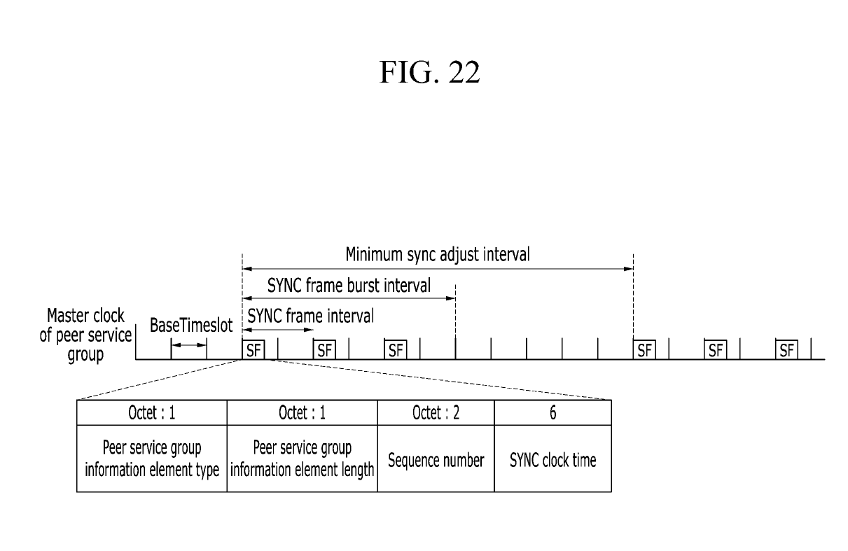

FIG. 22 is a diagram illustrating a synchronization frame according to an exemplary embodiment of the present invention.

In an exemplary embodiment of the present invention, the synchronization frame may be used for synchronizing base timeslots between a plurality of peer service groups. The synchronization frame according to an exemplary embodiment of the present invention may include a sequence number of the base timeslot and a sync clock time of the synchronization frame. The synchronization frame may also include a type and a length of a peer service group information element.

In this case, the peer service group information element is for peer service group synchronization, and the sync clock time of the synchronization frame represents a sequence number of a base timeslot in which the synchronization frame is transmitted.

The peer service group descriptor may provide information on transmission time of a synchronization frame.

In an exemplary embodiment of the present invention, a PAC device that is ‘master clock capable’ may listen to the synchronization frame during the interval of ‘2×minSyncAdjustInterval’. If the synchronization frame is not received within the 2×minSyncAdjustInterval, the PAC device that is ‘master clock capable’ starts to transmit a set of the synchronization frames. The set of synchronization frames means that the PAC device transmits the synchronization frame each sync frame interval. In this case, the synchronization frame interval may be determined by “a length of base timeslot×unit timeslot (baseTimeslotLength×unitTimeslot).

The PAC device may transmit the synchronization frame during a sync frame burst interval.

In an exemplary embodiment of the present invention, the synchronization frame may be successively transmitted during a predetermined interval. Thereafter, the transmission of the synchronization frame may be suspended, and may be restarted after a synchronization correction time is exceeded.

The synchronization according to an exemplary embodiment of the present invention may go on by receiving the timestamp when the peer discovery procedure is in progress.

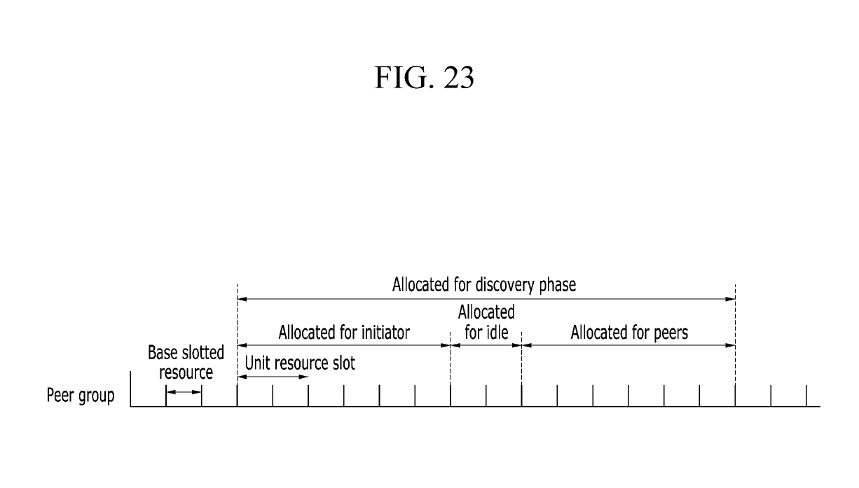

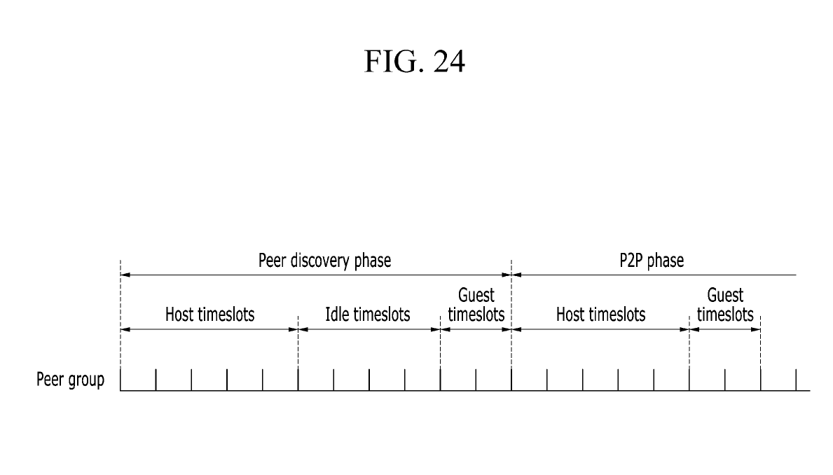

FIG. 23 is a diagram illustrating a resource allocation scheduling method of a peer service group according to an exemplary embodiment of the present invention.

In an exemplary embodiment of the present invention, resource allocation may be performed differently on each phase basis. In this case, the phase may be a clock synchronization phase, a peer discovery phase, a peer association phase, a P2P phase, or a peer disassociation phase. The length of a unit timeslot of a peer service group may be determined. The length of the unit timeslot is an integer multiple of a base slotted resource. A resource allocation scheduling method is described in the service profile of the peer service group.

FIG. 24 is a diagram illustrating timeslots allocated to a peer discovery phase and a P2P phase according to an exemplary embodiment of the present invention.

A service profile of a peer service group represents the combination of each phase or the resources allocated to each phase. Referring to FIG. 10, the peer discovery phase and the P2P phase are combined to provide the service in which short messages are exchanged in real time in the peer service group including moving PAC devices. The timeslots of ‘host-idle-guest-idle’ are allocated in the peer discovery phase. The timeslot of ‘host-guest-idle-guest-idle’ are repeatedly allocated in the P2P phase. In this case, the length of the unit timeslot is two base timeslots, the length of the host timeslot is three unit timeslots, the length of the idle timeslot is two unit timeslots, and the length of the guest timeslot is one unit timeslot.

A service profile of the peer service group may play a role of registering the profile. There may be 1,024 types of peer service groups on each class basis, and the length of the network operation may be determined by the host peer in the peer service group descriptor. The peer service group descriptor may include a phase descriptor and a resource allocation descriptor. The phase descriptor may include a peer discovery phase length, a peer association phase length, a P2P phase length, and a peer disassociation phase length. The resource allocation descriptor may include an idle timeslots length, a host timeslots length, a guest timeslots length, a group timeslots length, and a relay timeslots length.

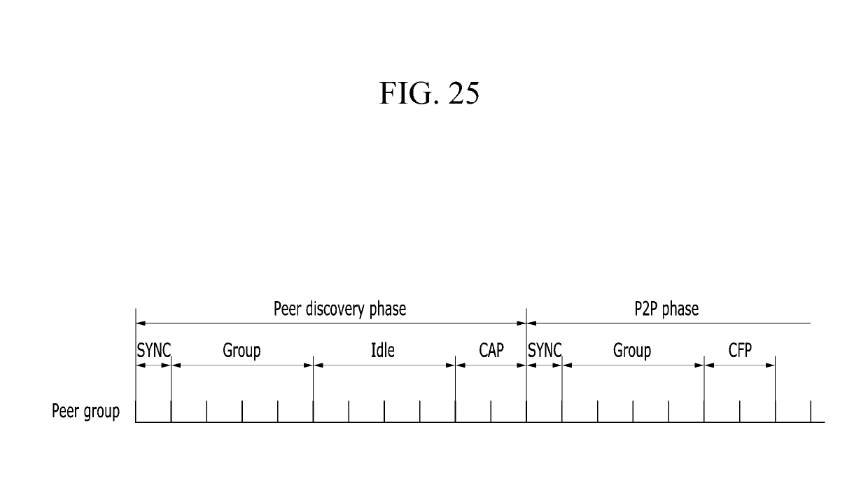

FIG. 25 is a diagram illustrating timeslots allocated to a peer discovery phase and a P2P phase according to another exemplary embodiment of the present invention.

Referring to FIG. 25, the service in which short messages are exchanged in real time (so called, ‘real-time short message exchange service) in the peer service group including moving PAC devices is described.

The service phase of the real-time short message exchange service may be constituted of ‘peer discovery phase’—‘P2P phase’. The superframe of the peer discovery phase may include ‘SYNC slot’-‘group slot’-‘idle slot’-‘CAP slot’, and the superframe of the P2P phase may include ‘SYNC slot’-‘group slot’-‘CFP slot’-‘idle slot’-‘CAP slot’-‘relay slot’-‘idle slot’. Each MAC slot is described as follows. The length of the MAC unit slot is two unit PHY slots, the length of the SYNC slot is one unit PHY slot, the length of the group slot is three unit MAC slots, the length of the idle slot is two unit MAC slots, and the length of the CAP slot is one unit MAC slot.

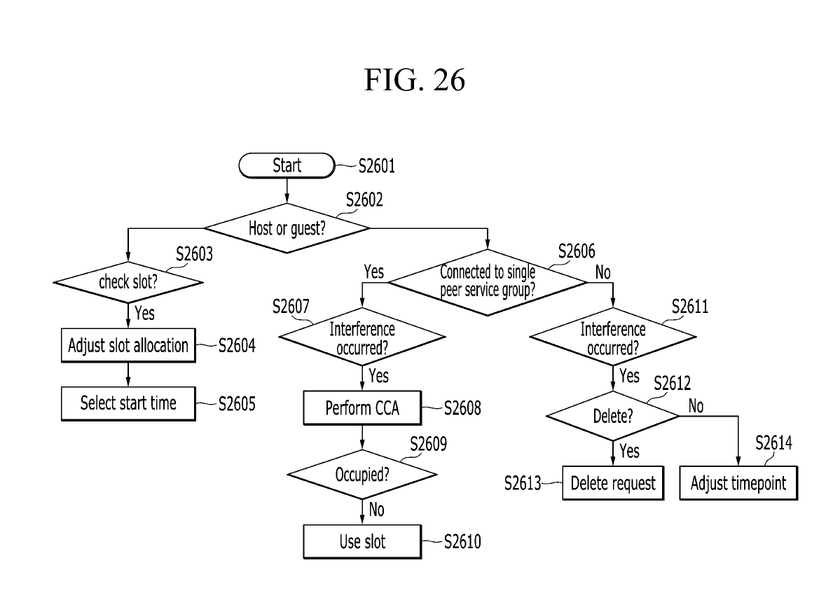

FIG. 26 is a flowchart illustrating an interference mitigation method according to an exemplary embodiment of the present invention.

In an exemplary embodiment of the present invention, each peer of a peer service group may mitigate interference by performing access control as a guest peer or as a host peer (S2601, S2602).

The access control method as a guest peer may be divided into a method that a peer participates in a single peer service group and a method that a peer participates in a multiple peer service group.

If the peer participates in a single peer service group, the peer may perform an access scheme according to the slot type of the peer service group. This is called an ‘implicit control’ method.

If the peer participates in multiple peer service groups, the peer may perform access control by scheduling peer communication between peer service groups. This is called an ‘explicit control’ method.

In the access control method as a host peer, the peer may select the start time of the P2P phase and schedule the peer communication between the peer service groups.

The interference avoidance method in the single peer service group may be implemented by allocating a dedicated timeslot for providing a service of high priority, and by backing-off the timeslot according to the priority.

Referring to FIG. 26, when the peer that provides a service is a host peer, the peer checks whether a slot of another peer service group exists (S2603), and adjusts the start point of the P2P phase or the slot allocated to the configuration element of the peer service group (S2604, S2605). That is, the host peer adjusts the start point of the P2P phase or the slot on each phase basis to not receive a frame in the time synchronization frame forwarding slot, a host portion slot of another peer service group, or the relay slot.

When the guest peer provides a service to the single peer service group (S2606, S2607), the guest peer determines whether interference has occurred with the other peer service group, selects the start point of CCA in a slot expected the interference, and performs the implicit access control method (S2608).

Thereafter the guest peer may use the slot if the slot is not occupied (S2609, S2610).

When the guest peer provides a service to the multiple peer service groups, the guest peer determines whether interference has occurred with the other peer service group (S2611), and may adjust the time point of the data transmission (S2614). Alternatively, the guest peer may not access a link resource, i.e., delete the request (S2613), and may not use the link access method.

For example, the guest peer adjusts the time point of the data transmission or does not perform link access to not receive the frame in the time synchronization frame forwarding slot, a host portion slot of each peer service group, or the relay slot based on the phase and the slot allocation information of the serving peer service group.

In another exemplary embodiment of the present invention, an interference avoidance method of a fully distributed mode is applied to the interference problem between peer service groups.

In the single peer service group, the interference problem may be solved through an access control scheme.

A group cast slot is used for transmitting a command frame for broadcasting, discovering, peer association/disassociation, and relay, and the distinguished back-off according to an access priority of the PAC device may be applied to the group cast slot. For example, the priority to the initiator or relay peer may be determined in the basis of the hashing value of the PAC device ID.

A CAP slot is used for transmitting a P2P command frame and a data frame, and the CCA may be applied along with random back-off to the CAP slot.

A CFP slot is a slot that is pre-allocated in the basis of the hashing value of a PAC device ID and is allocated through a peer connection. In this case, the CCA may be applied along with a fixed back-off.

Otherwise, in the multiple peer service groups, the interference problem may be solved through an interference avoidance scheme.

There are two different cases: a first case is that a peer performs access control method as a participant, and a second case is that a peer performs access control method as an initiator.

When a peer performs access control as a participant, the peer that participates in the single peer service group may use an implicit access control scheme.

The implicit access control scheme means applying an access scheme according to the slot type.

When a peer performs access control as a participant, the peer that participates in the multiple peer service groups may use an explicit access control scheme.

The explicit access control scheme means scheduling peer communication between peer service groups according to the link access.

When a peer performs access control as an initiator, the peer selects the start time of the PAC service, re-schedules the PAC service, and performs opportunistic transmission in the basis of designed statistical access.

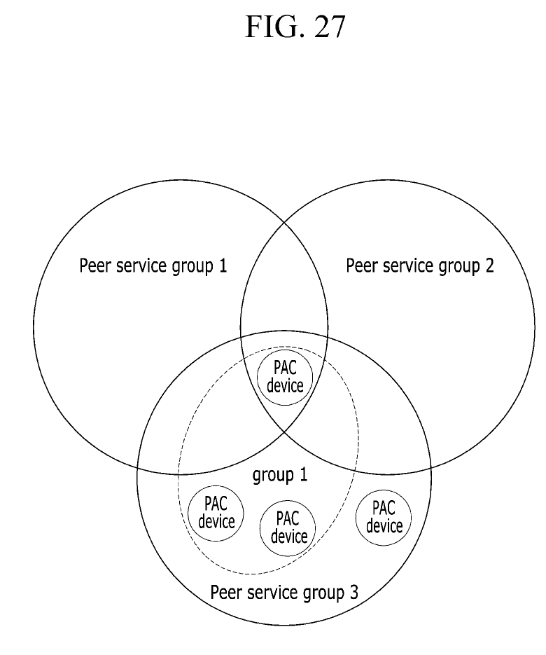

FIG. 27 is a diagram illustrating a peer group generated between peer service groups according to an exemplary embodiment of the present invention.

In an exemplary embodiment of the present invention, the peer group configuration method and the data transmission method of the peer service group are described through FIG. 27.

In FIG. 27, the PAC device groups included in a peer service group may collaborate with each other by sharing information. For example, the PAC device groups may provide a missing part of service specific information to other PAC device groups. The PAC device group constituted by at least one PAC device included in each peer service group may be generated by invitation between PAC devices or by grouping the other PAC devices.

A peer included in a peer service group may form a plurality of peer groups or participate in a peer group. In this case, the address of the peer included in a peer service group may include network ID, group ID, and local device ID, and the peer may simultaneously have a plurality of addresses.

In a single peer service group, each peer may unicast to the destination peer by using a “network ID+group ID+local device ID”. In a single peer service group, each peer may broadcast to the destination peer by using a “network ID+broadcast group ID+broadcast local device ID”. In a single peer service group, each peer may groupcast to the target peer by using a “network ID+group ID+broadcast local device ID”.

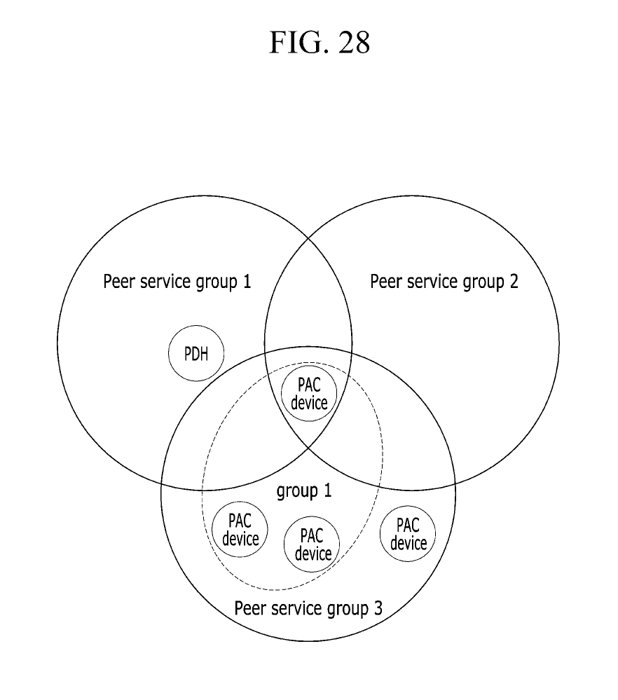

FIG. 28 is a diagram illustrating broadcasting of PAC device groups according to an exemplary embodiment of the present invention.

Referring to FIG. 28, each peer may use a broadcast frame instead of the address of the destination peer to broadcast to every peer service group included in a space. In this case, the network identifier may represent source network of the broadcast frame.

The broadcast may be performed through a PAC device broadcast address in a peer service group. In this case, the host peer may transmit a broadcast frame in a guest timeslot like a host timeslot.

Referring to FIG. 27 again, the configuration of the peer group may follow an implicit grouping method and an explicit grouping method. In the implicit grouping method, a PAC device may respond by transmitting a group data response to a group data request. That is, the device capability information and the service capability information required may be transmitted along with the group ID, and the other peer may transmit data in the group data response for the group data request. In accordance with the explicit grouping method, a PAC device transmits a response for the group data request, receives an ACK, and transmits a group data frame. In the explicit grouping method, the device capability information and the service capability information may also be transmitted along with the group ID, and the group may be formed with responding devices.

In an exemplary embodiment of the present invention, a QoS may mean multiple classes of data primitives. That is, the QoS may determine a data rate, implement a transmission of QoS, and be about a unicast, a groupcast and a broadcast.

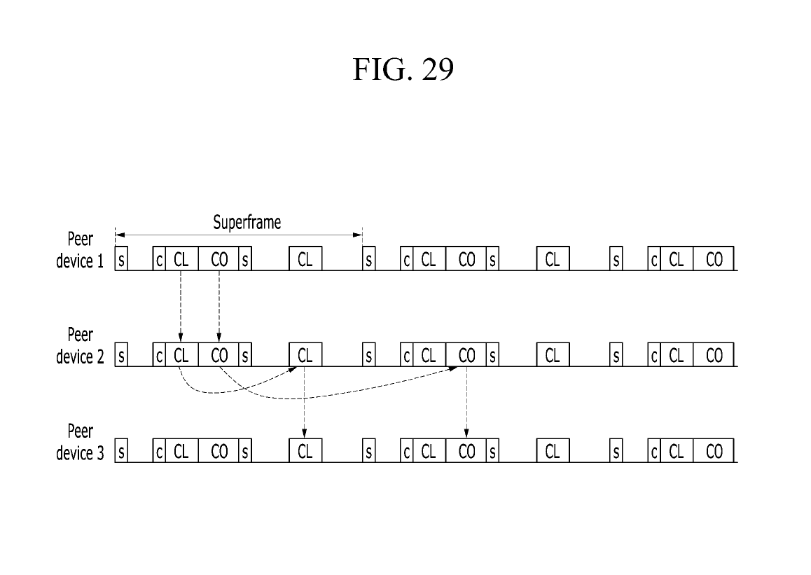

FIG. 29 is a diagram illustrating a multi-hop relaying method according to an exemplary embodiment of the present invention.

The multi-hop relaying method according to an exemplary embodiment of the present invention may expand the coverage of a peer service group. A PAC device may form a plurality of links with adjacent PAC devices that participate in the same peer service group. When a PAC device receives a frame whose destination is not the PAC device from an incoming link (for example, a link included in a cyclic superframe), the PAC device may select an outgoing link according to a relaying information route included in a relaying information element and transmit the frame through the outgoing link.

Relaying information may assign a link resource for the relay of a frame according to a destination peer link ID. In this case, the link resource is allocated to the PAC device that relays the frame. The link resource may be assigned by superframe ID, link period ID and slot ID. A PAC device may receive information about neighbor device's neighbor devices from linked adjacent PAC devices for constitution of the relaying information. Thereafter, the PAC device may determine a relative location map of PAC devices by assuming relative connection location between PAC devices of two hops from the link information of the neighbor device's neighbor devices. In this case, the relaying information may be used for determining a connection link that makes the PAC device forward the frame to the destination through the relative location map.

After the frame is relayed, a relaying count of the relaying information element in the relayed frame may be increased, and the destination peer link ID of the frame may be changed to outgoing link ID.

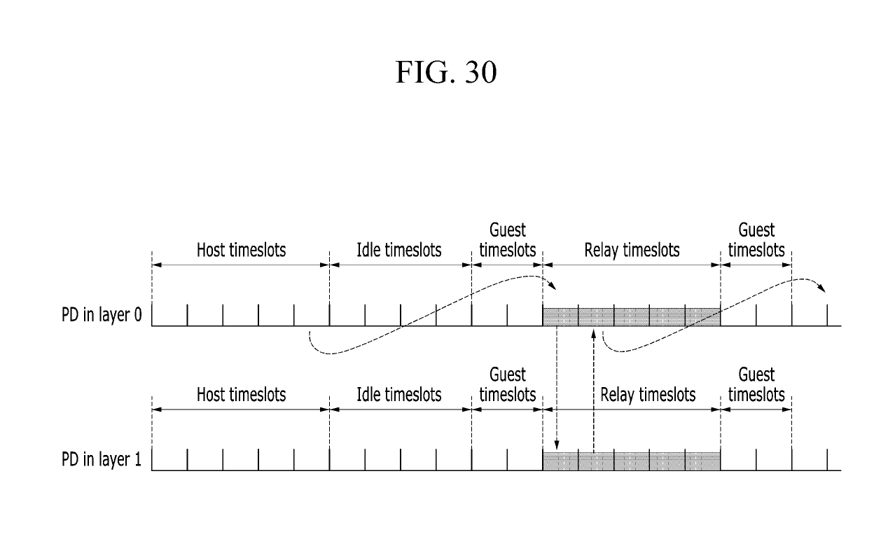

FIG. 30 is a diagram illustrating a multi-hop relaying method according to another exemplary embodiment of the present invention.

A relay capable PAC device (that is, relay peer) according to another exemplary embodiment of the present invention may find an isolated PAC device by receiving a device advertisement frame. A relay peer retransmits a clock synchronization frame, and retransmits an outward frame received the host peer in the relay timeslot allocated to the relay peer.

Thereafter, the isolated PAC device may perform CCA and transmit a frame in the relay timeslot.

The relay peer that receives an inward frame from the isolated PAC device may retransmit the inward frame in a slot that is selected based on the frame type.

In this case, the relay peer may change relay layer information of the outward frame received from the host peer and of the inward frame received from the connected peer with the relay peer, and may retransmit, in the relay timeslot, a frame of which relay layer information is changed.

The relay peer receives a relay association request from the lower layer peer, finds a frame from the lower layer peer in the host slot, guest slot or group slot, and may relay the frame in the outward portion of the relay slot.

After the relay peer receives a frame forwarding request from the lower layer peer, the relay peer selects one of the host slot, guest slot or group slot according to the destination address and relays the received frame.

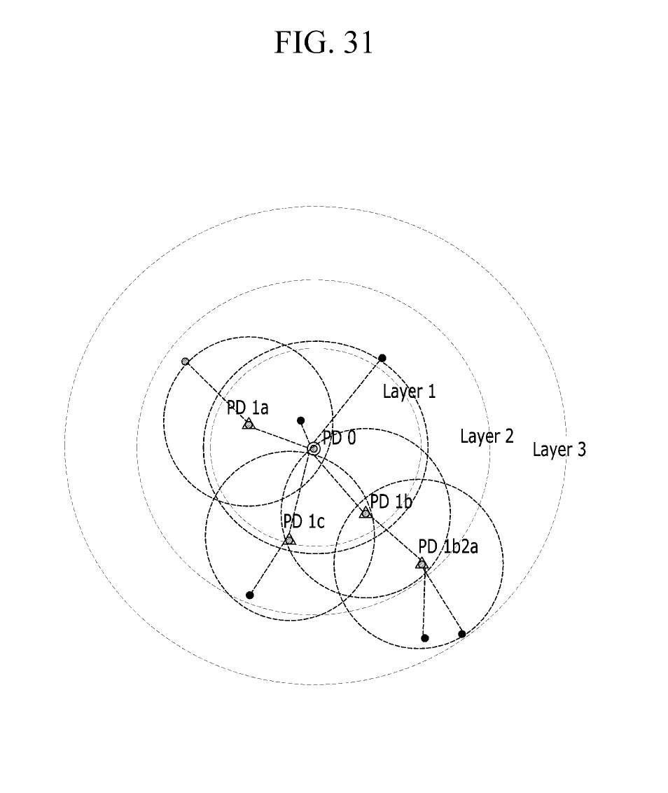

FIG. 31 is a diagram illustrating relative positioning according to an exemplary embodiment of the present invention.

The relative positioning according to an exemplary embodiment of the present invention may be operated based on link information between neighbor peers that is provided by a neighbor PAC device. The link information of the neighbor PAC device may be included in an adjacent information element as a link ID of a connected neighbor device and a received signal strength indicator (RSSI). Adjacent link information between neighbor peers of a two-hop distance collected from the neighbor PAC devices may be represented by a relation matrix based on positioning. In this case, the relation matrix may represent a connection matrix and an angular distance between PAC devices, and is for discovering a PAC device to perform relaying.

A PAC device map (PD map) may be mapped through the relation matrix between neighbor peers of a two-hop distance. In this case, the relation matrix between neighbor peers may include a neighbor local device identifier and an RSSI. The PD map may be distributed by device advertisement frame, and may be included in a neighbor relation list field of the device advertisement frame. The PD map may be used for conjecturing of relative location of the neighbor PAC device.

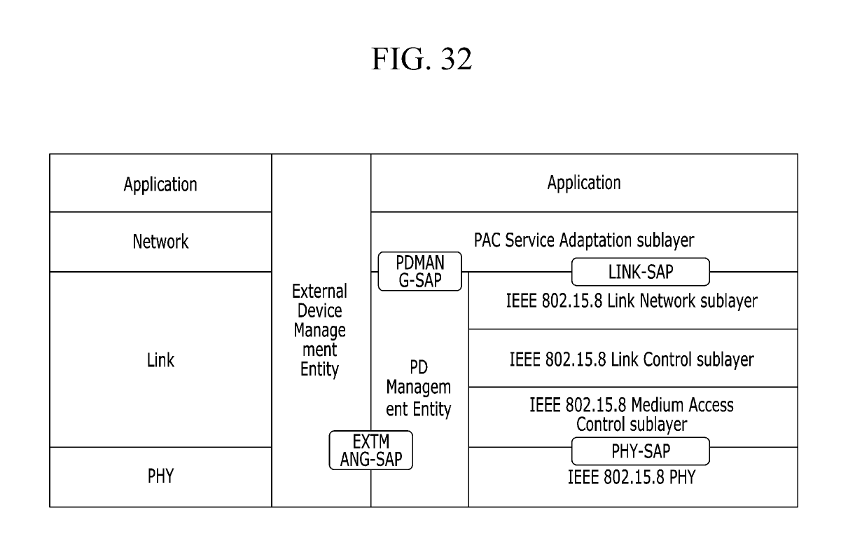

FIG. 32 is a diagram illustrating interaction of peer service group with an upper layer according to an exemplary embodiment of the present invention.

A service access point to the next upper layer may include a service access point of a link layer and a service access point of PD management.

A service access point to the external network may include a service access point of external PD management.

A plurality of service primitives may include a peer service group management primitive, a peer link management primitive, and a PAC device data primitive.

The peer service group management primitive is about EXTM-PUT-SERVICE, PDM-SET-SERVICE PDM-GET-SERVICE and PDM-START-DEVICE.

The peer link management primitive is about PDL-JOIN-PEER, PDL-LEAVE-PEER and PDL-MANAGE-PEER.

The PAC device data primitive is about PDD-DATA and PDD-DATA-GROUP.

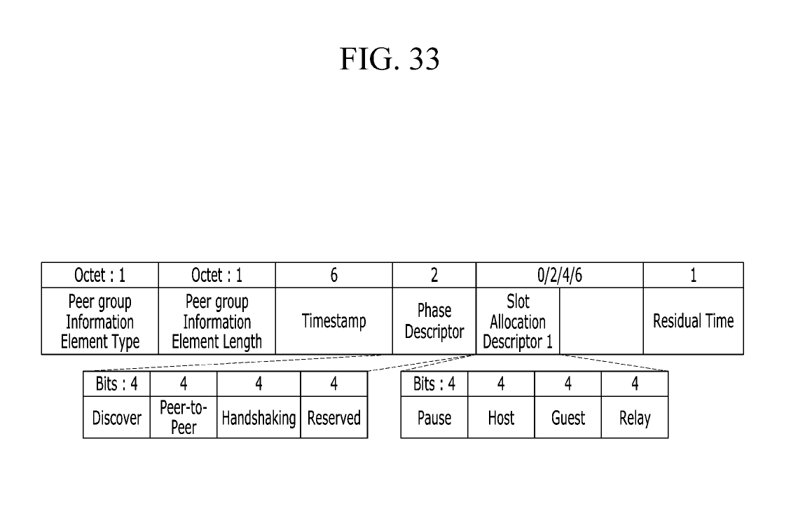

FIG. 33 is a diagram illustrating a network service method and a link resource allocation method according to an exemplary embodiment of the present invention.

In an exemplary embodiment of the present invention, the link resource allocation method in a wireless peer service group may be divided into an allocation method in a network life cycle step and an allocation method for a network constituent element (for example, host timeslots, guest timeslots, group timeslots, relay timeslots, and idle timeslots).

A peer service group according to an exemplary embodiment of the present invention may be constituted to fit the service characteristic through a combination of various kinds of phases. In this case, the phases may include a peer discovery phase, a handshaking phase in which a peer discovery request and data are simultaneously transmitted, a peer association phase, a P2P phase, and a peer dissociation phase.

In a peer service group that includes a moving host peer and a guest peer, a network service may be provided through the handshaking phase. In a peer service group that includes the moving host peer and the fixed guest peer, a network service may be provided in a way in which the host peer may perform the handshaking phase with the guest peer that performs the proxy host role among the fixed guest peer and the proxy host peer (that is one of the fixed guest peers) may perform the peer association phase, the P2P phase, and the peer dissociation phase.

In accordance with an exemplary embodiment of the present invention, each phase may include link resources allocated with the constituent elements of the peer service group. A base timeslot of the link resource is the time length for transmitting the time synchronization frame. The length of a unit timeslot of the peer service group may be an integer multiple of a base timeslot, and the unit timeslot may be used as a base unit for link resource allocation.

In an exemplary embodiment of the present invention, link resource may be allocated in the host peer, the guest peer, the group peer and the relay peer. The idle time may be represented in the unit timeslot. The duration time of each phase and link resource allocation of each phase may be provided through a phase descriptor and a slot allocation descriptor on phase basis. For example, the length of the allocated link resource may be represented as timeslot×2ⁿ, and the ‘n’ is 4 bits.

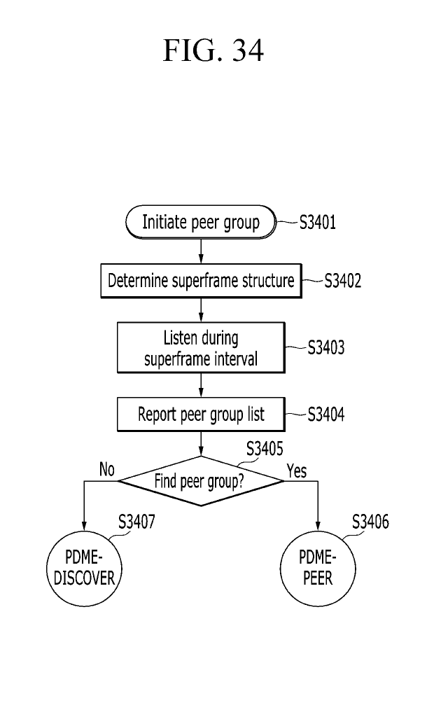

FIG. 34 to FIG. 38 are flowcharts illustrating a transmission method of MAC primitives according to an exemplary embodiment of the present invention.

The MAC primitives according to an exemplary embodiment of the present invention include the following. PDME stands for peer device management entity.

PDME-START.request/confirm

PDME-DISCOVER.request/indication/response/confirm

PDME-ADVERTISE.request/indication/response/confirm

PDME-PEER.request/indication/response/confirm

PDME-DEPEER.request/indication/response/confirm

PDME-REPEER.request/indication/response/confirm

PD-DATA.request/indication/confirm

PD-DATA-Group.request/indication/response/confirm

In the “PDME-START.request” primitive, a peer service type and a peer group ID may be provided from the upper layer.

The “PDME-START.confirm” primitive may be used for identifying a peer group list.

In the “PDME-DISCOVER.request” primitive, the peer service type, a peer ID, or a peer list may be provided from the upper layer.

In the “PDME-ADVERTISE.request” primitive, the peer service type, the peer ID, the length of MSDU (msduLength), an MSDU, and a capable peer service list may be provided.

In the “PDME-PEER.request” primitive, the peer ID and a peer link type may be provided.

In the “PDME-DEPEER.request” primitive and the “PDME-REPEER.request” primitive, the peer ID may be indicated by the upper layer.

In the “PD-DATA.request” primitive, the peer ID, the peer link type, and the length of the MSDU may be provided.

FIG. 34 is a flowchart illustrating a PDME-START procedure according to an exemplary embodiment of the present invention.

referring to FIG. 34, each PAC device initiates a peer group or participates in a peer group (S3401).

The PAC device may initiate the peer group through a peer service type and a peer list.

In this case, the peer service type and the peer list may be obtained through the PDME-START.request/confirm primitive.

Thereafter, the PAC device determines the superframe structure (S3402), listens to a frame of the neighbor PAC devices (S3403), and reports a peer group list (S3404). If the PAC device finds a peer group (S3405), the PAC device proceeds to the PDME-PEER procedure (S3406). If the PAC device does not find a peer group, the PAC device proceeds to the PDME-DISCOVER procedure (S3407).

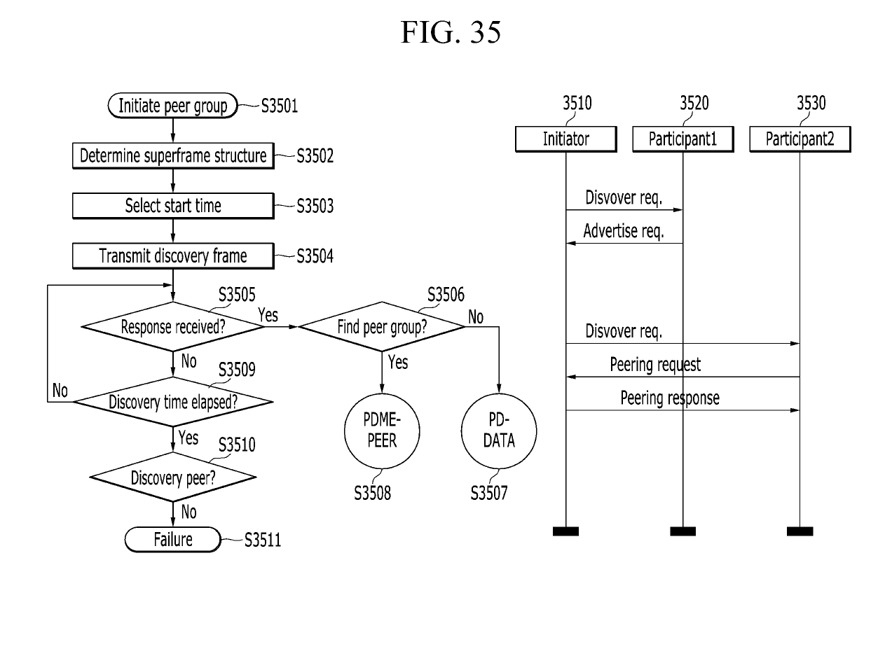

FIG. 35 is a flowchart illustrating the PDME-DISCOVER procedure according to an exemplary embodiment of the present invention.

Referring to FIG. 35, a PAC device may start the discovery procedure through a peer service type and a peer list (S3501). In this case, the peer service type and the peer list may be obtained through a response for the PDME-DISCOVER.request primitive that is transmitted and received between an initiator 3510 and participants 3520 and 3530.

The PAC device determines the superframe structure (S3502), and selects the start time of the peer service group (S3503). Thereafter, the PAC device transmits a discovery frame (S3504), and checks a response from other PAC devices (S3505).

If the PAC device receives a response from another PAC device, the PAC device determines whether a peer link is needed (S3506). If the peer link needs to be set up, the PAC device proceeds to the PDME-PEER procedure (S3507). If the peer link does not have to be set up, the PAC device proceeds to the PD-DATA procedure (S3508). The PDME-PEER procedure and the PD-DATA procedure are performed through a primitive exchange between an initiator (that is, a PAC device that initiates a peer service group) and a participant (that is, a PAC device that participates in a peer service group).

In this case, if a peer needs to be set up, the initiator transmits the PDME-DISCOVER.request primitive to the participant 1 and receives the PDME-ADVERTISE.request primitive from the participant 1. If the peer does not need to be set up, the participant transmits the PDME-DISCOVER.request primitive to the participant 2 and receives the PDME-PEER.request primitive from the participant 2. Thereafter, the initiator transmits the PDME-PEER.response primitive to the participant 2.

If the PAC device does not receive the response from the other device, the PAC device checks the initial discovery time (S3509). If the initial discovery time has elapsed, the PAC device checks to discover a peer (S3510). If the PAC device fails to discover a peer, the PAC device determines this to be a failure of generation of the peer service group (S3511). However, if the initial discovery time has not elapsed, the PAC device retransmits the discovery frame.

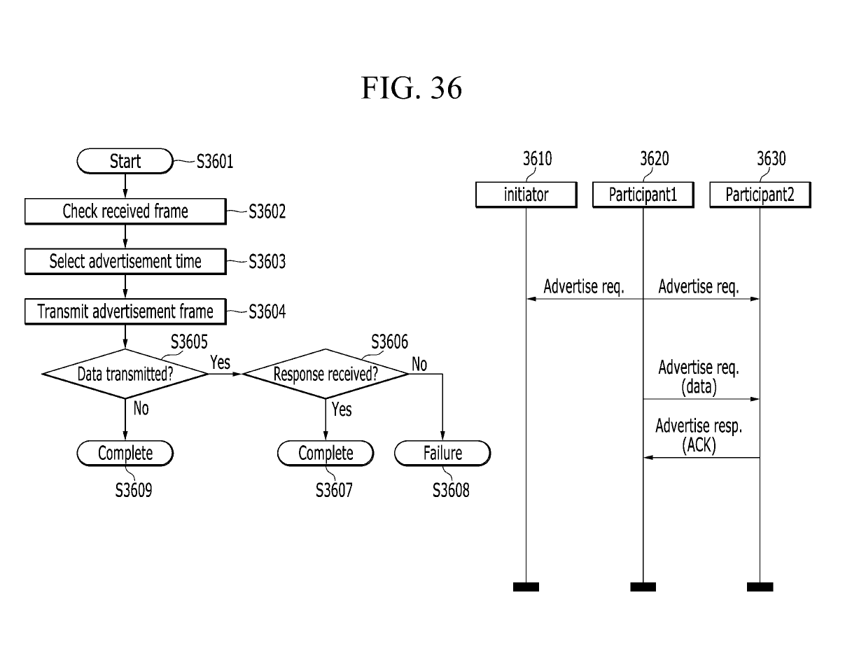

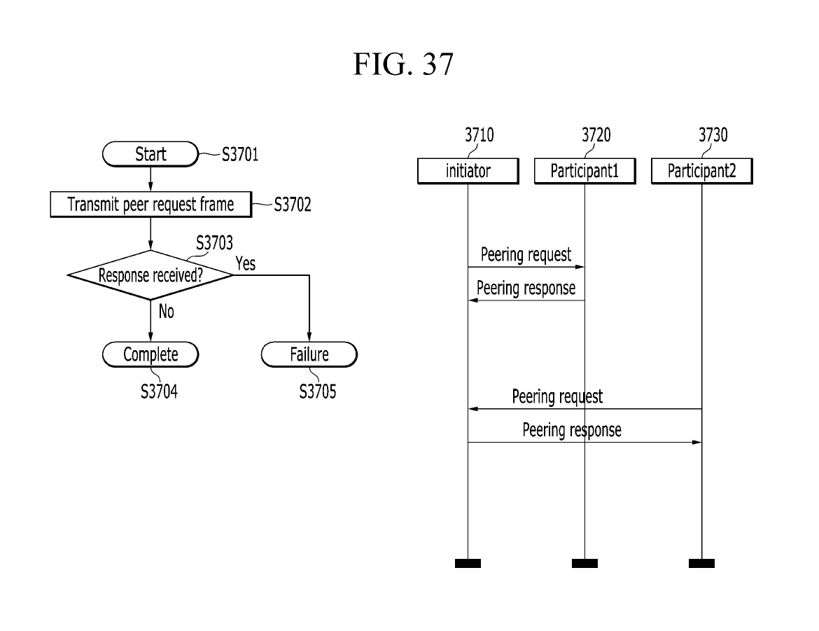

FIG. 36 is a flowchart illustrating the PDME-ADVERTISE procedure according to an exemplary embodiment of the present invention.

Referring to FIG. 36, a PAC device may start peer the advertisement procedure through a peer service type, a capable peer service list, a peer ID, or data (MSDU) (S3601). In this case, the peer service type, the capable peer service list, the peer ID and the data may be obtained from the response for to the PDME-ADVERTISE.request primitive that is transmitted and received between an initiator 3610 and participants 3620 and 3630.

Thereafter, the PAC device checks a received frame (S3602), and selects the advertisement time to transmit an advertisement frame on the basis of the received frame (S3603, S3604).

In this case, if the data is transmitted along with the advertisement frame (S3605), the PAC device completes the PDME-ADVERTISE procedure (S3609). If the PAC device transmits the data along with the advertisement frame, the PAC device may determine a success/failure of the PDME-ADVERTISE procedure according to the receipt of ACK (S3606). That is, if the ACK has been received from the other PAC devices, the PAC device completes the PDME-ADVERTISE procedure (S3607). But if the ACK has not been received, the PAC device determines this to be a failure of the PDME-ADVERTISE procedure (S3608).

In this case, the participant 1 may transmit a PDME-ADVERTISE.request primitive to the initiator and the participant 2. The participant 1 may also transmit data along with the PDME-ADVERTISE.request primitive to the participant 2, and checks for an ACK from the participant 2.

FIG. 37 is a flowchart illustrating the PDME-PEER procedure according to an exemplary embodiment of the present invention.

Referring to FIG. 37, a PAC device may start the PDME-PEER procedure through a peer ID and a peer link type (S3701). The PDME-PEER procedure is a procedure that generates a link along with a QoS parameter. In this case, the peer ID and the peer link type may be obtained from the PDME-PEER.request primitive that is transmitted and received between an initiator 3710 and participants 3720 and 3730.

Thereafter, the PAC device transmits a peering request frame (S3702) and checks for a response to the peering request frame (S3703). If the response has been received, the PAC device completes a peering procedure (S3704). But if the response has not been received, the PAC device determines this to be a failure of the peer procedure (S3705).

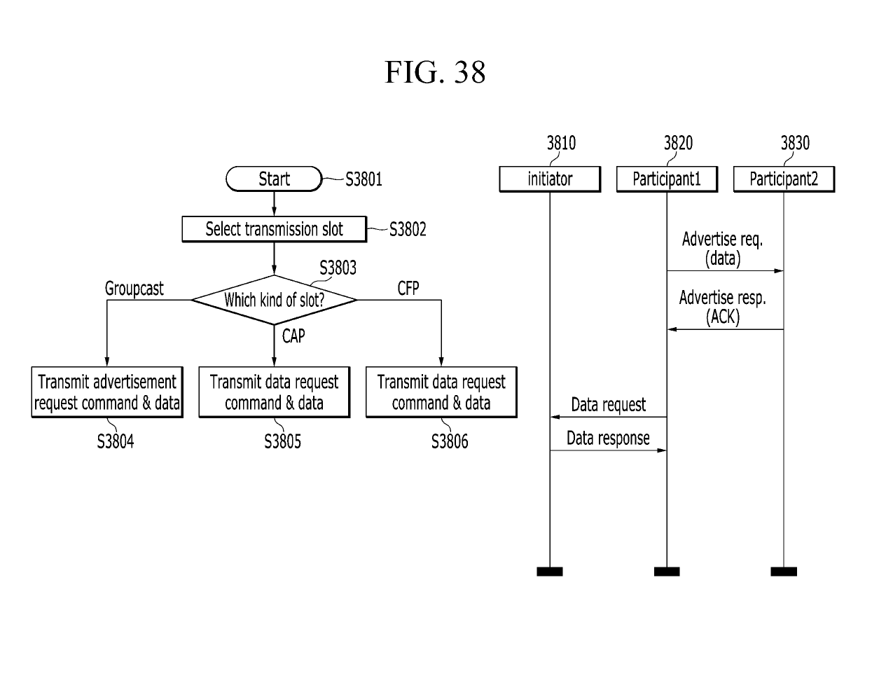

FIG. 38 is a flowchart illustrating a PD-DATA procedure according to an exemplary embodiment of the present invention.

Referring to FIG. 38, a PAC device may start the PD-DATA procedure through a peer ID, a peer link type, and an MSDU (S3801). In the PD-DATA procedure, the peer ID, the peer link type, and the MSDU may be obtained from the PD-DATA.request primitive that is transmitted and received between an initiator 3810 and participants 3820 and 3830.

Thereafter, the PAC device selects at least one timeslot for transmitting a data frame (S3802), and transmits different primitives on the slot type basis and data (S3803).

If the slot is a groupcast slot, the PAC device transmits an advertisement request command along with the data (S3804). If the slot is a CAP slot or a CFP slot, the PAC device transmits a data request command along with the data (S3805, S3806).

In an exemplary embodiment of the present invention, a MAC command frame may include a discovery request command, an advertisement request command, an advertisement response command, a peering request command, a eering response command, a de-peering request command, a de-peering response command, a re-peering request command, a re-peering response command, a data request command and a data response command.

As described above, according to an exemplary embodiment of the present invention, a peer device can efficiently access a link resource and reserve resources, and avoid interferences according to various kinds of service and required quality without resource scheduling and access control of the master coordinator.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a peer device accesses a link in a peer aware communication (PAC) network, the method comprising:
determining a phase based on service which is provided to another peer device, and
accessing the link which is included in a superframe that has a predetermined length according to the phase.

2. The method of claim 1, wherein the superframe includes at least one synchronization interval (SI).

3. The method of claim 2, wherein the SI includes at least one link period of a synchronization link period, a search link period, a control link period, a connectionless link (CL) period, a connection-oriented link (CO) period and an idle link period.

4. The method of claim 2, wherein the SI includes at least one slot of a synchronization slot, a search slot, a control slot, a contention access (CA) data slot, a contention free (CF) data slot and an idle slot.

5. The method of claim 2, wherein the SI includes a predetermined number of sub slots.

6. The method of claim 4, further comprising performing an access scheme to avoid interference according to a type of the slots.

7. The method of claim 4, wherein the synchronization slot, the search slot, the control slot, the CA data slot, the CF data slot, and the idle slot include at least one sub-slot.

8. The method of claim 1, wherein the superframe is a cyclic superframe which includes an active superframe and an inactive superframe.

9. The method of claim 8, wherein the active superframe includes a synchronization period and a search period, and the inactive superframe includes a search period if the phase is a search phase.

10. The method of claim 8, wherein the active superframe includes a synchronization period, a search period and a control period and the inactive superframe includes a control period if the phase is a peering phase.

11. The method of claim 8, wherein the active superframe includes at least one period of a synchronization period, a search period, a control period, a connectionless link (CL) period, and a connection-oriented (CO) link period, and the inactive superframe includes a synchronization period and an idle period if the phase is a peer to peer (P2P) phase.

12. The method of claim 1, wherein the peer device may transmit an advertising frame or a search frame together with data, and the superframe includes a synchronization interval (SI) in which a synchronization period, a search period, an idle period, a connectionless link (CL) period, and an idle period are included if the service is a unidirectional connectionless message transmission service.

13. The method of claim 1, wherein the peer device transmits a request frame or a response frame together with data, and the superframe includes a first synchronization interval (SI) in which a synchronization period, a search period, a control period, a connectionless link (CL) period and an idle period are included and second SI in which a synchronization period, a search period, an idle period, a CL period and an idle period are included if the service is a bidirectional connectionless message transmission service.

14. The method of claim 1, wherein the peer device generates a contention access (CA) link after searching for another device, and the superframe includes a synchronization interval (SI) in which a synchronization period, a search period, a control period, a connectionless link (CL) period, and an idle period are included if the service is a delay tolerant message transmission service.

15. The method of claim 1, wherein the superframe includes a first synchronization interval (SI) in which a synchronization period, a search period, a control period, a connectionless link (CL) period, a connection-oriented (CO) period, and an idle period are included and second SI in which a synchronization period, a search period, an idle period, a CL period, and an idle period are included if the service is a mixed type of traffic service.

16. The method of claim 1, wherein the peer device generates a contention access (CA) link after searching for another device, and the superframe includes a synchronization interval (SI) in which a synchronization period, a search period, a control period, an idle period, and a connection-oriented (CO) period are included if the service is a reliable message transmission service.

17. The method of claim 1, wherein the peer device may select a use of a slot that is included in a synchronization interval (SI) of the superframe and a length of the superframe, and the superframe is advertised by a superframe structure information element if the service is an open configurable superframe service.

18. A method in which a peer device reserves a resource in a peer aware communication (PAC) network, the method comprising:
scanning a control slot of a plurality of other peer devices in a vicinity thereof,
selecting a superframe and a slot that is included in the superframe based on a hashing value of peer link identification (ID), and
transmitting a peering request to one of the plurality of other peer devices through the selected superframe and the selected slot.

19. A method in which a peer device avoids interference between a plurality of peer groups in a peer aware communication (PAC) network, the method comprising:
accessing, if the peer device is a participant of a first peer group among the plurality of peer groups, a resource according to priority of a type of service that is operated in the plurality of peer groups; and
accessing, if the peer device is an initiator of a second peer group among the plurality of peer groups, a resource according to priority of a type of service that is operated in the plurality of peer groups after selecting a start time of a superframe.

20. The method of claim 19, further comprising operating, if the peer device is an initiator of the second peer group, opportunistic transmission based on designed statistical access.
